(19) United States
(12) Patent Application Publication
(10) Pub. No.: US 2024/0356342 A1
(43) Pub. Date: Oct. 24, 2024

(54) POWER ADAPTER, CHARGING SYSTEM, AND CHARGING METHOD

(71) Applicant: HONOR DEVICE CO., LTD., Shenzhen, Guangdong (CN)

(72) Inventors: Yao ZHAO, Shenzhen (CN); Yabiao WANG, Shenzhen (CN); Ruipu XUE, Shenzhen (CN); Haibin ZHOU, Shenzhen (CN); Xiaoyang WANG, Shenzhen (CN)

(21) Appl. No.: 18/264,866

(22) PCT Filed: Dec. 29, 2022
(86) PCT No.: PCT/CN2022/143549

§ 371 Date: Aug. 9, 2023

(30) Foreign Application Priority Data
Jan. 11, 2022 (CN) 202210025502.4

(51) Int. Cl. H02J 7/00; H02J 7/02

(52) U.S. Cl. CPC H02J 7/0013; H02J 7/00714; H02J 7/007182; H02J 7/007192; H02J 7/02

(57) ABSTRACT

This application provides a power adapter, a charging system, and a charging method. The power adapter includes a control module, a conversion module, a power regulation module, and at least one charging port. The power regulation module includes N switch tubes. The control end of the conversion module and the control ends of the N switch tubes are electrically connected to the control module. The output end of the conversion module is electrically connected to the first ends of the N switch tubes separately. The second ends of the N switch tubes are electrically connected to the charging port separately. The control module receives at least one charging voltage and at least one charging current, and determines an output voltage of the conversion module based on the charging voltage and the charging current.

This application claims priority to Chinese Patent Application No. 202210025502.4, filed with the China National Intellectual Property Administration on Jan. 11, 2022 and entitled “POWER ADAPTER, CHARGING SYSTEM, AND CHARGING METHOD”, which is incorporated herein by reference in its entirety.

### TECHNICAL FIELD

This application relates to the field of communication technologies, and in particular, to a power adapter, a charging system, and a charging method.

### BACKGROUND

With the development of science and technology, the functions of a terminal become more powerful. A user can carry out office work and entertainment on a terminal so that the terminal has become an indispensable part of people's everyday life. However, the battery durability of the terminal is limited. Therefore, the needs of the user may be met by use of a plurality of terminals or a terminal powered by a plurality of internal batteries.

When the user uses a plurality of terminals or a terminal powered by a plurality of internal batteries, how to simultaneously charge the plurality of batteries in a mobile phone or simultaneously charge a plurality of batteries corresponding to a plurality of mobile phones through one power adapter is an urgent technical problem to be solved.

### SUMMARY

To resolve the foregoing technical problem, this application provides a power adapter, a charging system, and a charging method to charge a plurality of batteries in a terminal or a plurality of batteries corresponding to a plurality of mobile phones. The power adapter and the charging system are structurally simple and cost-efficient.

According to a first aspect, an embodiment of this application provides a power adapter. The power adapter includes: a control module, a conversion module, a power regulation module, and at least one charging port. The conversion module includes an input end, an output end, and a control end. The power regulation module includes N switch tubes, each switch tube includes a first end, a second end, and a control end, and N is a positive integer greater than or equal to 1. The control end of the conversion module and the control ends of the N switch tubes are all electrically connected to the control module. The output end of the conversion module is electrically connected to the first ends of the N switch tubes separately. The second ends of the N switch tubes are electrically connected to the charging port separately. The control module is configured to: receive at least one charging power sent by at least one terminal, where each charging power includes a charging voltage and a charging current; and determine an output voltage of the conversion module based on the charging power. The conversion module receives a first control signal sent by the control module, converts an alternating-current voltage received by the input end into the output voltage, and transmits the output voltage to the first end of each of the switch tubes. The control module sends a second control signal to the switch tube. The switch tube operates in a linear region or a saturation region based on the second control signal, regulates voltage and current of the second end to be the charging voltage and the charging current respectively, and outputs the voltage and current through the charging port. The voltage and current at the second end of one of the switch tubes correspond to one charging power.

In contrast to the practice of disposing a power regulation structure in the terminal, the power regulation structure disposed in the power adapter according to this application reduces the designed area of a mainboard of the terminal, thereby facilitating placement of other structures inside the terminal. Moreover, the power regulation structure according to this embodiment of this application regulates the charging voltage and charging current by utilizing the characteristic that the resistance is variable when the switch tube operates in the linear region. The structure is simple and space-efficient, and is conducive to miniaturization design of the power adapter.

In some possible implementations, the control module is further configured to send a second control signal to the switch tube based on the output voltage, so as to facilitate regulation of the voltage and current at the second end of the switch tube and improve the accuracy of the output charging voltage and charging current.

In some possible implementations, a number of the charging ports is M. The M charging ports include L₁ charging pins, L₂ charging pins, . . . , and Lₙ charging pin, respectively, and n, M, L₁, L₂, . . . , and Lₙ are all positive integers greater than or equal to 1. The second ends of the N switch tubes are electrically connected to (L₁+L₂+ . . . +Lₙ) charging pins in one-to-one correspondence. That is, the number of charging ports may be 1 or more. When the number of charging ports is more than one, the number of each charging port may be one or more, so as to facilitate charging for the batteries in at least one terminal. The number of batteries in each terminal may be one or more. In the power adapter according to this embodiment of this application, the charging voltage and charging current of each battery can be controlled flexibly, thereby improving user experience in charging a plurality of batteries in a terminal or charging a plurality mobile phones.

In some possible implementations, on the basis that the number of the charging ports is M, the number of the charging ports is N. Each charging port includes one charging pin. The second ends of the N switch tubes are electrically connected to the N charging pins in one-to-one correspondence. In this way, one battery in a terminal can be charged through one charging port.

In some possible implementations, on the basis that the number of the charging ports is M, the number of the charging ports is one. The charging port includes N charging pins. The second ends of the N switch tubes are electrically connected to the N charging pins in one-to-one correspondence.

As an example, the charging port is electrically connected to one terminal. The terminal includes N batteries. In the power adapter according to this embodiment of this application, the charging voltage and charging current of each battery can be controlled flexibly, thereby improving user experience in charging a plurality of batteries in a terminal.

As an example, the charging port is electrically connected to N terminals. Each terminal includes N batteries. In the power adapter according to this embodiment of this application, the charging voltage and charging current of each battery can be controlled flexibly, thereby improving user experience in charging a plurality of mobile phones.

In some possible implementations, the second ends of the N switch tubes are electrically connected to the control module. The control module is configured to collect a voltage value and a current value of the second end of each switch tube, determine whether the voltage value at the second end of the switch tube is identical to the charging voltage, and determine whether the current value at the second end of the switch tube is identical to the charging current; and, change, when the voltage value at the second end of the switch tube is different from the charging voltage and/or the current value at the second end of the switch tube is different from the charging current, the second control signal output to the switch tube, so as to change an operating point of the switch tube in the linear region. In other words, the voltage and current at the second end of the switch tube are monitored in real time to determine whether the voltage and current at the second end of the switch tube are the charging voltage and the charging current respectively, thereby ensuring the accuracy of charging.

In some possible implementations, the power adapter further includes N voltage filtering and regulation modules. The N voltage filtering and regulation modules are electrically connected to the second ends of the N switch tubes in one-to-one correspondence. Each of the voltage filtering and regulation modules is configured to filter the voltage and current at the second end of the switch tube to let the power adapter output a steady direct current.

In some possible implementations, the control module is further configured to determine a power loss of the switch tube based on an operating point of the switch tube in the linear region, determine whether the power loss is greater than a preset power loss value, and turn off the switch tube when the power loss is greater than the preset power loss value, thereby avoiding a relatively high heat loss that is prone to damage the switch tube.

In some possible implementations, the power adapter further includes a temperature sensor. The temperature sensor is configured to collect a temperature value of the switch tube, and send the temperature value of the switch tube to the control module. The control module is configured to determine whether the temperature value of the switch tube is higher than a preset temperature value, and turn off the switch tube when the temperature value of the switch tube is higher than the preset temperature value, thereby avoiding a relatively high heat loss that is prone to damage the switch tube.

In some possible implementations, the control module is configured to determine a maximum voltage based on the charging voltage in the charging power, and adjust, based on the maximum voltage, the first control signal sent to the conversion module, so that the conversion module converts the alternating-current voltage received by the input end into the maximum voltage. In this way, at least one of the switch tubes is caused to operate in the saturation region, thereby avoiding the problem of heat emitted when the switch tube operates in the linear region.

In some possible implementations, when at least one of the switch tubes operates in the linear region, the control module is configured to adjust the second control signal output to at least one switch tube so that the at least one switch tube is turned on intermittently. The operating mode of the other switch tubes is a normally open mode. In this way, a switch tube turned on intermittently can alleviate self-heating by operating intermittently. When the switch tube turned on intermittently is turned off, if the switch tube working in a normally open mode operates in the linear region at this time, the output voltage of the conversion module can be changed by the control module to cause the switch tube to operate in the saturation region, thereby alleviating the heating of the switch tube and improving energy efficiency.

In some possible implementations, the switch tube includes any semiconductor switch tube such as a metal oxide semiconductor tube or a triode.

In some possible implementations, the voltage filtering and regulation module includes a capacitor, and the structure is simple and cost-efficient.

According to a second aspect, an embodiment of this application provides a charging method, applied to the power adapter according to the first aspect. The charging method includes: receiving at least one charging power sent by at least one terminal, where each charging power includes a charging voltage and a charging current; determining an output voltage of the conversion module based on the charging power; sending the first control signal to the conversion module so that the conversion module converts an alternating-current voltage received by the input end into the output voltage; and sending the second control signal to the switch tube so as to make the switch tube operate in the linear region or the saturation region.

In contrast to the practice of disposing the power regulation structure in the terminal, the charging method according to this application disposes the power regulation structure in the power adapter, thereby reducing the designed area of a mainboard of the terminal, and facilitating placement of other structures inside the terminal. Moreover, the power regulation structure according to this embodiment of this application regulates the charging voltage and charging current by utilizing the characteristic that the resistance is variable when the switch tube operates in the linear region. The structure is simple and space-efficient, and is conducive to miniaturization design of the power adapter.

In some possible implementations, the sending the second control signal to the switch tube includes: sending the second control signal to the switch tube based on the output voltage, so as to facilitate regulation of the voltage and current at the second end of the switch tube and improve the accuracy of the output charging voltage and charging current.

In some possible implementations, the second end of each of the switch tubes is electrically connected to the control module, and the charging method further includes: collecting the voltage and current at the second ends of the N switch tubes; determining whether a voltage at the second end of an i^{th} switch tube is identical to a charging voltage corresponding to the i^{th} switch tube: adjusting, when the voltage at the second end of the i^{th} switch tube is not identical to the charging voltage corresponding to the i^{th} switch tube, the second control signal so that the voltage at the second end of the i^{th} switch tube is identical to the charging voltage corresponding to the i^{th} switch tube: determining, when the voltage at the second end of the i^{th} switch tube is identical to the charging voltage corresponding to the i^{th} switch tube, whether a current at the second end of the i^{th} switch tube is identical to a charging current corresponding to the i^{th} switch tube: adjusting, when the current at the second end of the i^{th} switch tube is not identical to the charging current corresponding to the i^{th} switch tube, the second control signal so that the current at the second end of the i^{th} switch tube is identical to the charging current corresponding to the i^{th} switch tube; and returning, when the current at the second end of the i^{th} switch tube is identical to the charging current corresponding to the i^{th} switch tube, to perform the step of determining whether the voltage at the second end of the i^{th} switch tube is identical to the charging voltage corresponding to the i^{th} switch tube until completion of detecting the voltage and current at the second ends of all the N switch tubes, where 1≤i≤N, and i is a positive integer. In other words, the voltage and current at the second end of the switch tube are monitored in real time to determine whether the voltage and current at the second end of the switch tube are the charging voltage and the charging current respectively, thereby ensuring the accuracy of charging.

In some possible implementations, the charging method further includes: determining a power loss of the switch tube based on an operating point of the switch tube in the linear region: determining whether the power loss is greater than a preset power loss value; and turning off the switch tube when the power loss is greater than the preset power loss value, thereby avoiding a relatively high heat loss that is prone to damage the switch tube.

In some possible implementations, the power adapter further includes a temperature sensor. The temperature sensor is configured to collect a temperature value of the switch tube, and send the temperature value of the switch tube to the control module. The charging method further includes: determining whether the temperature value of the switch tube is higher than a preset temperature value, and turning off the switch tube when the temperature value of the switch tube is higher than the preset temperature value, thereby avoiding a relatively high heat loss that is prone to damage the switch tube.

In some possible implementations, the determining an output voltage of the conversion module based on at least two charging powers includes: determining a maximum voltage based on the charging voltage; and adjusting, based on the maximum voltage, the first control signal sent to the conversion module, so that the conversion module converts the alternating-current voltage received by the input end into the maximum voltage. In this way, at least one of the switch tubes is caused to operate in the saturation region, thereby avoiding the problem of heat emitted when the switch tube operates in the linear region.

According to a third aspect, an embodiment of this application provides a charging system, including the power adapter according to the first aspect and a terminal. The terminal includes an external port and a battery. The external port is electrically connected to the charging port. The power adapter charges the battery in the terminal through the charging port and the external port to achieve all effects of the power adapter.

In some possible implementations, a number of the charging ports is M. The M charging ports include L₁ charging pins, L₂ charging pins, . . . , and Lₙ charging pin, respectively, and n, M, L₁, L₂, . . . , and Lₙ are all positive integers greater than or equal to 1. The second ends of the N switch tubes are electrically connected to (L₁+L₂+ . . . +Lₙ) charging pins in one-to-one correspondence. A number of the terminals is Q, and the Q terminals include P₁ external pins together with P₁ batteries, P₂ charging pins together with P₂ batteries, . . . , and Pₘ charging pins and Pₘ batteries, respectively, where the Pₘ charging pins are electrically connected to the Pₘ batteries in one-to-one correspondence, and m, Q, P₁, P₂, . . . , and Pₘ are all positive integers greater than or equal to 1. The power adapter charges the (P₁+P₂+ . . . +Pₙ) batteries in the Q terminals through the (L₁+L₂+ . . . +Lₙ) charging pins and the (P₁+P₂+ . . . +Pₙ) charging pins.

In some possible implementations, a number of the charging port is one. The charging port includes N charging pins. The second ends of the N switch tubes are electrically connected to the N charging pins in one-to-one correspondence. The terminal includes N batteries. The external port includes N external pins. The N external pins are electrically connected to the N batteries in one-to-one correspondence. The N external pins are electrically connected to the N charging pins in one-to-one correspondence.

In some possible implementations, the number of the charging port is one. The charging port includes N charging pins. The second ends of the N switch tubes are electrically connected to the N charging pins in one-to-one correspondence. The number of the terminals is N, each of the terminals includes a battery, and the external port of each of the terminals includes one external pin. The external pin of the terminal is electrically connected to the battery. The external pins of the N terminals are electrically connected to the N charging pins in one-to-one correspondence.

In some possible implementations, the number of the charging ports is N, and each of the charging ports includes one charging pin. The second ends of the N switch tubes are electrically connected to the N charging pins in one-to-one correspondence. The number of the terminals is N, each of the terminals includes a battery, and the external port of each of the terminals includes one external pin. The external pin of the terminal is electrically connected to the battery. The external pins of the N terminals are electrically connected to the charging pins of the N charging ports in one-to-one correspondence.

### BRIEF DESCRIPTION OF DRAWINGS

FIG. 1 shows an output characteristic curve of an NMOS tube;

FIG. 2 is one of schematic diagrams of application scenarios of a power adapter according to an embodiment of this application:

FIG. 3 is a schematic structural diagram of a circuit corresponding to FIG. 2:

FIG. 4 is a schematic structural diagram of a power adapter according to an embodiment of this application:

FIG. 5 is a schematic structural diagram of a power supply, a power adapter, and a mobile phone according to an embodiment of this application:

FIG. 6 is a schematic structural diagram of another power adapter according to an embodiment of this application:

FIG. 7 is a schematic structural diagram of another power adapter according to an embodiment of this application:

FIG. 8 is a schematic structural diagram of a charging port according to an embodiment of this application:

FIG. 9 is a schematic structural diagram of another charging port according to an embodiment of this application;

FIG. 10 is a schematic structural diagram of another charging port according to an embodiment of this application:

FIG. 11 is a schematic structural diagram of another charging port according to an embodiment of this application:

FIG. 12A and FIG. 12B are a flowchart of a charging method according to an embodiment of this application:

FIG. 13 is one of schematic diagrams of application scenarios of a power adapter according to an embodiment of this application:

FIG. 14 is a schematic structural diagram of a circuit corresponding to FIG. 13:

FIG. 15 is a schematic structural diagram of another power supply, another power adapter, and a mobile phone according to an embodiment of this application:

FIG. 16A and FIG. 16B are a flowchart of another charging method according to an embodiment of this application:

FIG. 17 is one of schematic diagrams of application scenarios of a power adapter according to an embodiment of this application:

FIG. 18 is a schematic structural diagram of a circuit corresponding to FIG. 17:

FIG. 19 is a schematic structural diagram of another power adapter according to an embodiment of this application:

FIG. 20 is a schematic structural diagram of another power supply, another power adapter, and a mobile phone according to an embodiment of this application:

FIG. 21 is one of schematic diagrams of application scenarios of a power adapter according to an embodiment of this application:

FIG. 22 is a schematic structural diagram of a circuit corresponding to FIG. 21:

FIG. 23 is a schematic structural diagram of another power supply, another power adapter, and a mobile phone according to an embodiment of this application:

FIG. 24 is one of schematic diagrams of application scenarios of a power adapter according to an embodiment of this application:

FIG. 25 is a schematic structural diagram of a circuit corresponding to FIG. 24; and

FIG. 26 is a schematic structural diagram of another power supply, another power adapter, and a mobile phone according to an embodiment of this application.

### DETAILED DESCRIPTION

The following clearly and thoroughly describes the technical solutions in some embodiments of this application with reference to the accompanying drawings appended hereto. Apparently, the described embodiments are merely some rather than all of embodiments of this application. Based on embodiments of this application, all other embodiments obtained by a person of ordinary skill in the art without creative efforts shall fall within the protection scope of this application.

In this specification, the term “and/or” is merely used to describe an association relationship between associated objects, and indicates that three relationships may exist. For example, A and/or B may indicate the following: Only A exists, both A and B exist, and only B exists.

The terms “first”, “second”, and the like in the specification and claims of embodiments of this application are used to distinguish between different objects, and are not used to indicate a specific sequence of objects. For example, a first target object and a second target object are used to distinguish between different target objects, but are not used to describe a specific sequence of the target objects.

In embodiments of this application, the term such as “as an example” or “for example”, is used to represent giving an example, an illustration or a description. Any embodiment or design solution described as an “exemplary” or “for example” in the embodiments of this application should not be explained as being more preferred or having more advantages than other embodiments or design solutions. Exactly, use of the word such as “as an example” or “for example” is intended to present a concept in a specific manner.

In the descriptions of the embodiments of this application, unless otherwise specified, “a plurality of” means two or more. For example, a plurality of processing units refer to two or more processing units. A plurality of systems refer to two or more systems; and a plurality of systems refer to two or more systems.

For ease of description, the following first describes the concept of the switch tube operating in a linear region and a saturation region mentioned in an embodiment of this application.

Before the description, it is to be noted that the switch tube mentioned in an embodiment of this application may be any semiconductor switch tube such as a metal oxide semiconductor (Metal Oxide Semiconductor, MOS) tube or a triode. When the switch tube is a MOS tube, the MOS tube may be an NMOS tube or a PMOS tube. When the switch tube is a triode, the triode may be a PNP-type triode or an NPN-type triode. The following description uses an example in which the switch tube is an NMOS tube, and all embodiments of this application are described using the example in which the switch tube is an NMOS tube.

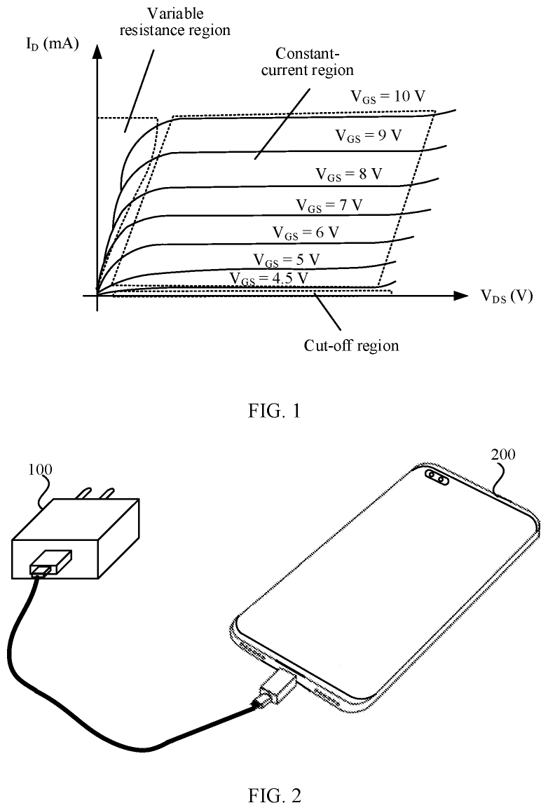

FIG. 1 shows an output characteristic curve of an NMOS tube, in which the abscissa VDs represents a drain-source voltage, the ordinate ID represents a drain current, and V_{GS} represents a gate-source voltage. Referring to FIG. 1, the output characteristics of a MOS tube may be divided into three regions: a cut-off region (also called an off-state region), a constant current region (also called a saturation region), and variable resistance region (also called a linear region). When V_{GS} is greater than a threshold voltage (Vth) of the MOS tube, ID first increases linearly with the increase of VDs, and then tends to be gentle. The phase of linear increase is called a variable resistance region. At this phase, the MOS tube is equivalent to a resistor, with a resistance value being the reciprocal of the slope thereof. The resistance value of the resistor varies with V_{GS}. In other words, in this region, the MOS tube is equivalent to a variable resistor controlled by V_{GS}. To be specific, by adjusting the gate voltage of the MOS tube, the resistance value of the MOS tube in the variable resistance region (also called a linear region) can be adjusted. Understandably, when the resistance value changes, the voltage and current that pass through the MOS tube change accordingly. The gentle phase is called a constant current region (also called a saturation region). At this phase, ID does not vary with VDs. That is, the current passing through the MOS tube remains unchanged. Because an on-resistance R_{ds}(on) of the MOS tube is tiny, the voltage drop is very small after passage through the MOS tube. The voltage of the source is almost equal to the voltage of the drain when the MOS tube is turned on.

Based on this, an embodiment of this application provides a power adapter and a charging system. The charging system includes the power adapter and a terminal. The power adapter can charge the terminal. In contrast to the practice of disposing the power regulation structure in the terminal, the charging method according to this application disposes the power regulation structure in the power adapter, thereby reducing the designed area of a mainboard of the terminal, and facilitating placement of other structures inside the terminal. Moreover, the power regulation structure according to this embodiment of this application regulates the charging power (that is, regulates the charging voltage and charging current) by utilizing the characteristic that the resistance is variable when the switch tube operates in the linear region. The structure is simple and space-efficient, and is conducive to miniaturization design of the power adapter. The terminal may be a mobile phone, a notebook computer, a tablet computer, a personal digital assistant (personal digital assistant, PDA for short), an in-vehicle computer, a television set, a smart wearable device (such as a smart watch), a media player, a smart home appliance, or the like. A specific form of the terminal is not particularly limited in this embodiment of this application. For ease of description, this embodiment of this application is described using an example in which the terminal is a mobile phone.

The following describes the application scenario, structure, and charging principles of a power adapter according to this embodiment of this application using a mobile phone as an example.

### Scenario I

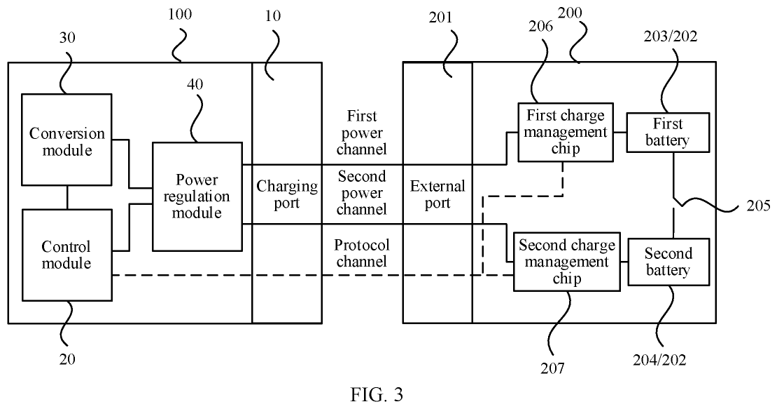

As shown in FIG. 2 and FIG. 3, FIG. 2 and FIG. 3 are schematic diagrams of an application scenario of a power adapter according to an embodiment of this application. The power adapter 100 includes structures such as a charging port 10, a control module 20, a conversion module 30, and a power regulation module 40. The mobile phone 200 includes at least two batteries. FIG. 3 gives an illustration in which the mobile phone 200 includes two batteries 202. The two batteries 202 are a first battery 203 and a second battery 204 respectively. The power adapter 100 is electrically connected to the mobile phone 200 by one charging port 10. To be specific, in this application scenario, the power adapter 100 charges two batteries (the first battery 203 and the second battery 204) in a mobile phone 200 through one charging port 10.

The following describes various structures and the charging principles of the power adapter 100 in the above scenario in detail.

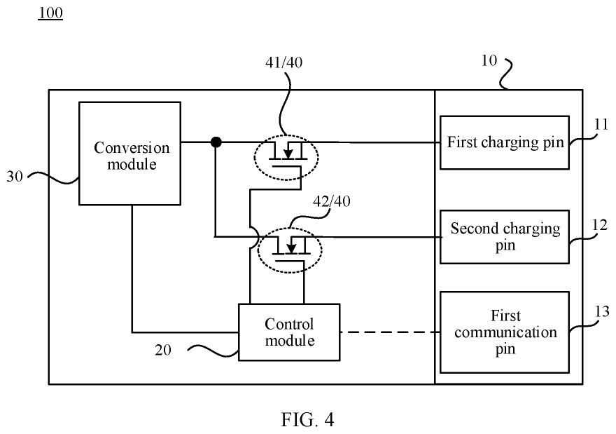

Referring to FIG. 4, the power regulation module 40 includes two switch tubes. The two switch tubes are a first switch tube 41 and a second switch tube 42 respectively. The charging port 10 includes a first charging pin 11, a second charging pin 12, and a first communication pin 13. Both the first switch tube 41 and the second switch tube 42 include a first end, a second end, and a control end. The conversion module 30 includes an input end, an output end, and a control end. When the input end of the conversion module 30 is electrically connected to a power supply 300, the input end of the conversion module 30 is configured to receive an alternating-current voltage output by the power supply 300. The output end of the conversion module 30 is electrically connected to the first end of the first switch tube 41 and the first end of the second switch tube 42 separately. The second end of the first switch tube 41 is electrically connected to the first charging pin 11. The second end of the second switch tube 42 is electrically connected to the second charging pin 12. The control end of the conversion module 30, the control end of the first switch tube 41, and the control end of the second switch tube 42 are electrically connected to the control module 20 separately. The first communication pin 13 is electrically connected to the control module 20.

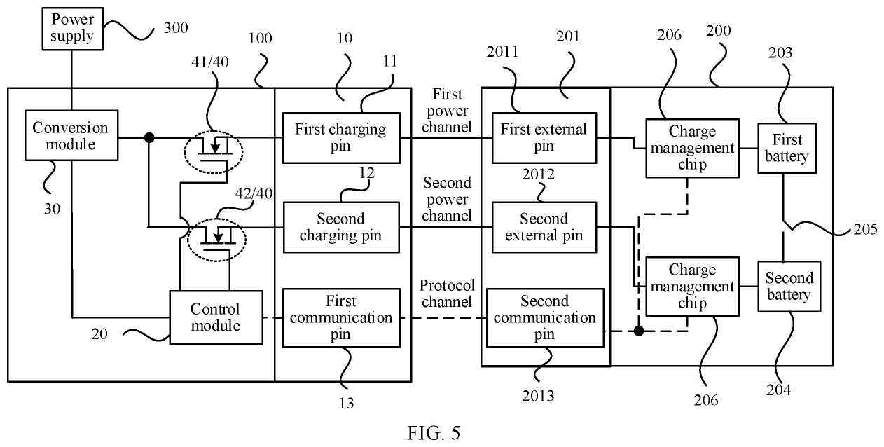

Referring to FIG. 5, when the power adapter 100 needs to charge the first battery 203 and the second battery 204 in the mobile phone 200, one end of the power adapter 100 is electrically connected to the power supply 300, and the other end of the power adapter is electrically connected to the mobile phone 200. That is, the input end of the conversion module 30 of the power adapter 100 is electrically connected to the power supply 300, and the power adapter 100 is electrically connected to the mobile phone 200 by the charging port 10. The external port 201 of the mobile phone 200 includes a first external pin 2011, a second external pin 2012, and a second communication pin 2013. The first external pin 2011 is electrically connected to the first charging pin 11. The second external pin 2012 is electrically connected to the second charging pin 12. The second communication pin 2013 is electrically connected to the first communication pin 13. In this way, electrical connection is implemented between the power adapter 100 and the mobile phone 200. In addition, in the mobile phone 200, one of charging management chips 206 is electrically connected to the first battery 203 and the first external pin 201 separately, and another charging management chip 206 is electrically connected to the second battery 204 and the second external pin 2012 separately: The second communication pin 2013 is electrically connected to the two charging management chips 206 separately. A path formed by the output end of the first switch tube 41, the first charging pin 11, the first external pin 201, and the charge management chip 206 electrically connected to the first external pin 201 is a first power channel. A path formed by the output end of the second switch tube 42, the second charging pin 12, the second external pin 2012, and the charging management chip 206 electrically connected to the second external pin 2012 is a second power channel. A path formed by the first communication pin 13 and the second communication pin 2013 is a protocol channel.

It is hereby noted that the power channel means a path through which the power adapter 100 transmits the charging voltage and the charging current when charging the batteries 202 in the mobile phone 200. Different batteries 202 correspond to different paths. To be specific, the first battery 203 corresponds to the first power channel, and the second battery 204 corresponds to the second power channel. Communication between the power adapter 100 and the mobile phone 200 is performed through a protocol channel.

Specifically, when the power adapter 100 or the mobile phone 200 detects that the power adapter 100 is connected to the mobile phone 200, the mobile phone 200 and the power adapter 100 exchange a communication protocol through the first communication pin 13 and the second communication pin 2013 to complete protocol handshake and determine whether the channels between the power adapter 100 and the mobile phone 200 match the batteries, that is, determine whether the first power channel corresponds to the first battery 203, and whether the second power channel corresponds to the second battery 204.

It is hereby noted that the method of how the power adapter 100 or the mobile phone 200 detects connection of the power adapter 100 to the mobile phone 200 is not limited in this embodiment of this application. For example, when a level change is detected on the first external pin 2011 and the second external pin 2012, the mobile phone 200 determines that the power adapter 100 is connected to the mobile phone 200. For another example, when a level change is detected on the second communication pin 2013, the mobile phone 200 determines that the power adapter 100 is connected to the mobile phone 200.

In addition, the method for determining whether the power channels between the power adapter 100 and the mobile phone 200 match the batteries is not limited in this embodiment of this application. For example, when determining that the power adapter 100 is connected to the mobile phone 200, the control module 20 controls the first switch tube 41 to operate in the saturation region and controls the second switch tube 42 to operate in the linear region based on a preset rule. As can be seen from above, when the first switch tube 41 operates in the saturation region, the current passing through the first switch tube 41 remains unchanged, and the on-resistance of the first switch tube 41 is tiny. The voltage of the first end is almost equal to the voltage of the second end of the first switch tube 41. When the second switch tube 42 operates in the linear region, the resistance of the second switch tube 42 is relatively large, and a voltage drop is generated when the current passes through the second switch tube 42. Therefore, the voltage at the second end of the second switch tube 42 is lower than the voltage at the first end of the second switch tube. In addition, the voltage at the first end of the first switch tube 41 is equal to the voltage at the first end of the second switch tube 42, and therefore, the voltage at the second end of the second switch tube 42 is lower than the voltage at the second end of the first switch tube 41. In this way, the voltage on the first power channel is higher than the voltage on the second power channel. The mobile phone 200 collects the voltage value on the first power channel. If the mobile phone 200 determines that the voltage on the first power channel is high enough, it indicates that the first power channel matches the first battery 203, and correspondingly, the second power channel matches the second battery 204. If the mobile phone 200 determines that the voltage on the first power channel is not higher than the voltage on the second power channel, it indicates that the first power channel does not match the first battery 203, and the second power channel does not match the second battery 204. The purpose of determining whether the power channels match the batteries is to prevent the first power channel from improperly corresponding to the second battery 204. The improper correspondence causes the first power channel to charge the second battery 204, and causes the second power channel to charge the first battery 203.

It is to be noted that the method for the mobile phone 200 to collect the voltage value on the power channel is not limited herein, as long as the voltage on the power channel can be determined.

After the channel matching is completed, the mobile phone 200 sends the required charging power values of the first battery 203 and the second battery 204 to the control module 20 of the power adapter 100 through a protocol channel. The required charging power values are a charging voltage value and a charging current value required by the first battery 203, and a charging voltage value and a charging current value required by the second battery 204. Based on the charging voltage value and charging current value required by the first battery 203 and the charging voltage value and charging current value required by the second battery 204, the control module 20 determines that the first power channel needs to transmit the charging voltage required by the first battery 203, and determines that the second power channel needs to transmit the charging voltage required by the second battery 204.

Due to differences in the factors such as capacity and state of charge between the first battery 203 and the second battery 204, the charging voltage required by the first battery 203 is generally different from the charging voltage required by the second battery 204. The control module 20 determines a maximum voltage value among the charging voltage value required by the first battery 203 and the charging voltage value required by the second battery 204, and sends a first control signal to the conversion module 30 based on the required maximum voltage value. The conversion module 30 regulates the output voltage of the conversion module based on the first control signal, so that the output voltage can meet the charging voltages required by different power channels. The voltage output by the conversion module 30 may be identical to the maximum voltage value, or may be higher than the maximum voltage value. As an example, the charging voltage required by the first battery 203 is 10 V, and the charging voltage required by the second battery 204 is 9.9 V. The voltage can meet the required charging voltages of different channels as long as the voltage output by the conversion module 30 is greater than or equal to 10 V. Therefore, if the output voltage of the conversion module 30 is less than 10 V, for example, is 9.9 V, the output voltage fails to meet the charging voltage required by the first power channel.

When the voltage output by the conversion module 30 is the maximum voltage value among the charging voltage required by the first battery 203 and the charging voltage required by the second battery 204, that is, when the output voltage is 10 V, the control module 20 controls the first switch tube 41 to operate in the saturation region through the second control signal output to the control end of the first switch tube 41 (in order to be distinguished from the signal received by the control end of the second switch tube 42, the second control signal received by the control end of the first switch tube 41 is referred to as a first control sub-signal), so that the voltage on the first power channel is 10 V. The control module controls the second switch tube 42 to operate in the linear region through the second control signal output to the control end of the second switch tube 42 (in order to be distinguished from the signal received by the control end of the first switch tube 41, the second control signal received by the control end of the second switch tube 42 is referred to as a second control sub-signal), so that the voltage on the second power channel is 9.9 V. That is because the charging voltage required by the first battery 203 is 10 V. When the first switch tube 41 operates in the saturation region, the voltage at the first end of the first switch tube 41 is identical to the voltage at the second end of the first switch tube. Therefore, the voltage transmitted on the first power channel is the charging voltage 10 V required by the first battery 203. However, the charging voltage required by the second battery 204 is 9.9 V. When the second switch tube 42 operates in the linear region, the second switch tube 42 is equivalent to a resistor. The resistance value of the resistor may vary with the second control sub-signal. In this way, the voltage at the second end of the second switch tube 42 is decreased and can be controlled to be 9.9 V. In other words, by adjusting the second control sub-signal at the control end of the second switch tube 42, the resistance value of the second switch tube 42 in the variable resistance region (also a linear region) is adjusted, thereby adjusting the voltage and current at the second end of the second switch tube 42, and causing the voltage and current to be the charging voltage and the charging current required by the second battery 204. In this way, the charging voltage and charging current are allocated to the first power channel and the second power channel, thereby enabling fast charging for the first battery 203 and the second battery 204 of the mobile phone 200. Understandably, as can be seen from above, even if the first switch tube 41 operates in the saturation region, a small voltage drop still occurs. Therefore, when the conversion module 30 is required to output a voltage of 10 V, the control module 20 may control the output voltage of the conversion module 30 to be slightly higher than 10 V, for example, to be 10.1 V or 10.2 V.

In addition, the mobile phone 200 collects the capacity value and state of charge value of the first battery 203 and the second battery 204 in real time, determines an amount of power to be added, and then, based on the amount of power to be added and the current voltage status of the battery, determines the charging power values (that is, the charging voltage value and the charging current value) required by the first battery 203 and the second battery 204 at this time, and sends the values to the control module 20 of the power adapter 100. Based on the charging power values required by the first battery 203 and second battery 204 at this time, the control module 20 redetermines a charging voltage to be transmitted on the first power channel and required for charging the first battery 203, and redetermines a charging voltage to be transmitted on the second power channel and required for charging the second battery 204. Subsequently, based on the charging voltages to be transmitted by different power channels, the control module determines a maximum charging voltage required, and, based on the maximum voltage, regulates the voltage output by the conversion module 30, so that the output voltage of the conversion module 30 meets the required charging voltages of different channels. In addition, the control module 20 re-controls the first switch tube 41 to operate in the linear region or the saturation region, and re-controls the second switch tube 42 to operate in the linear region or the saturation region. The specific principles are the same as the process described above, and are omitted here.

In addition, during the charging, the mobile phone 200 monitors in real time whether the state of charge (SOC) of the first battery 203 and the second battery 204 reaches a preset SOC (for example, 100% SOC). When the SOC of the first battery 203 reaches the preset SOC, the mobile phone sends a charging-completed message to the control module 20 through a protocol channel. The control module 20 turns off the first switch tube 41 based on the charging-completed message. When the SOC of the second battery 204 reaches the preset SOC, the secondary battery sends a charging-completed message to the control module 20 through the protocol channel. The control module 20 turns off the second switch tube 42 based on the charging-completed message.

Optionally, after completion of charging the first battery 203 and the second battery 204, when the first battery 203 and the second battery 204 need to be discharged in parallel (to supply power to other components in the mobile phone 200), the switch tube 205 between the first battery 203 and the second battery 204 is closed, and normally enters a parallel discharge mode. If the power adapter 100 is still electrically connected to the mobile phone 200 at this time, the power adapter 100 still maintains at least one power channel for trickle-charging the first battery 203 and the second battery 204. Alternatively, the first battery 203 and the second battery 204 may be discharged separately. That is, the first battery 203 supplies power to some components in the mobile phone 200, and the second battery 204 supplies power to some other components in the mobile phone 200.

It is to be noted that, in a case that the power adapter 100 can charge two batteries in the mobile phone 200, the specific structure and batteries of the mobile phone 200 are not particularly limited herein. In other words, regardless of the specific structure inside the mobile phone 200, the power adapter 100 can charge a mobile phone containing at least two batteries. The mobile phone is not limited to the mobile phone 200 shown in FIG. 5.

In addition, understandably, when a current passes through a resistor, a loss of electrical energy is prone to occur, and the electrical energy is converted into heat energy, with the resistor generating heat. As mentioned above, when the switch tube operates in the linear region, the switch tube is equivalent to a resistor. Similarly, when the current passes through the switch tube operating in the linear region, the switch tube generates heat. When the switch tube heats up severely, the heat may cause damage to the switch tube.

Considering that the first switch tube 41 and/or the second switch tube 42 may operate in the linear region, that is, the first switch tube 41 and/or the second switch tube 42 may generate heat, in order to prevent an excessive heat loss from damaging the first switch tube 41 and the second switch tube 42, it is necessary to monitor the heat loss of the first switch tube 41 and the second switch tube 42 in real time and compare the heat loss of the first switch tube 41 and the heat loss of the second switch tube 42 with a preset heat loss value (a heat loss value causing damage to the switch tube) during the charging. When the heat loss of the first switch tube 41 is greater than the preset heat loss value, the first switch tube 41 is turned off until the heat loss of the first switch tube 41 is less than or equal to the preset heat loss value, whereupon the first switch tube 41 is turned on to continue to operate. When the heat loss of the second switch tube 42 is greater than the preset heat loss value, the second switch tube 42 is turned off until the heat loss of the second switch tube 42 is less than or equal to the preset heat loss value, whereupon the second switch tube 42 is turned on to continue to operate. This prevents an excessive heat loss from damaging the first switch tube 41 and the second switch tube 42. The presetting of heat value is not particularly limited herein. A person skilled in the art may preset the heat value according to the actual situation, as long as the heat loss of the switch tube is prevented from causing damage to the switch tube.

The heat of the first switch tube 41 and the second switch tube 42 is monitored in various ways. Three practicable monitoring manners are described below.

In an example, the control module 20 may determine the resistance value of the first switch tube 41 and the current on the first power channel as well as the resistance value of the second switch tube 42 and the current on the second power channel based on the operating points of the first switch tube 41 and the second switch tube 42 in the linear region. In addition, based on the resistance value of the first switch tube 41 and the current on the first power channel, the control module may determine the power loss of the first switch tube 41, and then determine a heat loss of the first switch tube 41. The heat loss is calculated as Q₁=I₁²×R₁×t₁, where Q₁ is the heat loss of the first switch tube 41, R₁ is the resistance value of the first switch tube 41, I is the current value on the first power channel, and t is the operating time of the first switch tube 41. In addition, based on the resistance value of the second switch tube 41 and the current on the second power channel, the control module may determine the power loss of the second switch tube 42, and then determine a heat loss of the second switch tube 42. The heat loss is calculated as Q₂=I₂²×R₂×t₂, where Q₂ is the heat loss of the second switch tube 42, R₂ is the resistance value of the second switch tube 42, I₂ is the current value on the second power channel, and t₂ is the operating time of the second switch tube 42. This method enables predicting the heat loss of the first switch tube 41 and the second switch tube 42 and then turning off the switch tube with a high heat loss in advance, thereby preventing the heat loss from damaging the first switch tube 41 and the second switch tube 42.

Alternatively, the mobile phone 200 may determine the heat loss of the first switch tube 41 based on parameters such as the current and voltage on the first power channel and the model of the first switch tube 41. Also, the mobile phone 200 may determine the heat loss of the second switch tube 42 based on parameters such as the current and voltage on the second power channel and the model of the second switch tube 42. When it is determined that the heat loss of the first switch tube 41 is greater than a preset heat loss value, the mobile phone sends a first turn-off signal to the control module 20 of the power adapter 200, so that the control module 20 turns off the first switch tube 41 based on the first turn-off signal. When it is determined that the heat loss of the second switch tube 42 is greater than a preset heat loss value, the mobile phone sends a second turn-off signal to the control module 20 of the power adapter 200, so that the control module 20 turns off the second switch tube 42 based on the second turn-off signal.

In another example, a temperature sensor (not shown in the drawing) is disposed in the power adapter 200. The temperature sensor collects the temperature value of the first switch tube 41 and the second switch tube 42 in real time, and sends the collected temperature values of the first switch tube 41 and the second switch tube 42 to the control module 20. The control module 20 compares the temperature values of the first switch tube 41 and the second switch tube 42 with a preset temperature value (a temperature causing damage to the switch tube) separately: When the temperature of the first switch tube 41 exceeds the preset temperature value, the control module turns off the first switch tube 41. When the temperature of the second switch tube 42 exceeds the preset temperature value, the control module turns off the first switch tube 41. This manner improves the accuracy and reliability of detection, and avoids the impact caused by the factors such as the environment of the mobile phone to the switch tube.

In another example, not only the control module 20 (or the mobile phone 200) monitors the power loss of the first switch tube 41 and the second switch tube 42 in real time to determine whether heat is generated, but also a temperature sensor may be disposed in the power adapter 100. In other words, the heat loss of the first switch tube 41 and the second switch tube 42 is monitored in the above two manners simultaneously, thereby further improving the accuracy and reliability of the monitoring.

In addition, when the charging power of the first battery 203 is different from the charging power of the second battery 204, that is, when the charging voltage and the charging current transmitted on the first power channel are different from those transmitted on the second power channel, in order to alleviate the severe heating of the switch tube operating in the linear region and enhance the energy efficiency, the operating mode of the switch tube corresponding to one of the batteries may be set to an on-off mode, that is, intermittently on and off. In a case of turning on the switch tube, the switch tube may be turned on in a saturation manner or a linear manner. The operating mode of the switch tube corresponding to the other battery is a normally-on mode, and this switch tube may operate in the saturation region or linear region. In this way, the switch tube turned on intermittently can alleviate self-heating by operating intermittently. When the switch tube turned on intermittently is turned off, if the switch tube working in a normally open mode operates in the linear region at this time, the output voltage of the conversion module 30 can be changed by the control module 20 to cause the switch tube to operate in the saturation region, thereby alleviating the heating of the switch tube and improving energy efficiency.

In addition, the mobile phone 200 monitors the status of the first battery 203 and the second battery 204 in real time. When determining that one of the first battery 203 or the second battery 204 is damaged, the mobile phone sends a turn-off message to the control module 20 through the protocol channel, where the turn-off message is an instruction to turn off the switch tube corresponding to the damaged battery. Based on the turn-off message, the control module 20 turns off the damaged switch tube. In this way, the faulty battery is automatically isolated by controlling the turn-off of the switch tube, and the method is simple.

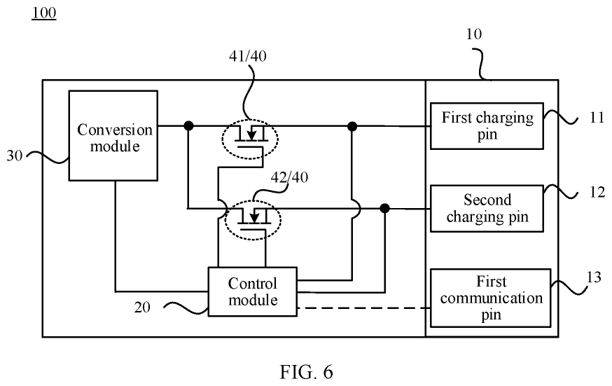

In addition, in order to ensure accuracy of the current and voltage transmitted on the first power channel and the second power channel, where the accuracy means that the voltage and current on the first power channel are the charging current and charging voltage required by the first battery 203 and that the voltage and current on the second power channel are the charging current and charging voltage required by the second battery 204, referring to FIG. 6, the second end of the first switch tube 41 and the second end of the second switch tube 42 are electrically connected to the control module 20 separately. During charging of the first battery 203 and the second battery 204, the control module 20 monitors in real time the current and voltage transmitted on the first power channel and the second power channel. When the voltage on one of the power channels is different from (greater or less than) a preset voltage (for example, the charging voltage required by the battery), or when the current on one of the power channels is different from a preset current (for example, the charging current required by the battery), the control module 20 changes the second control signal output to the switch tube, thereby changing the operating point of the switch tube in the linear region. In this way, the voltage and current output by this switch tube are the charging voltage and the charging current, respectively, required by the battery.

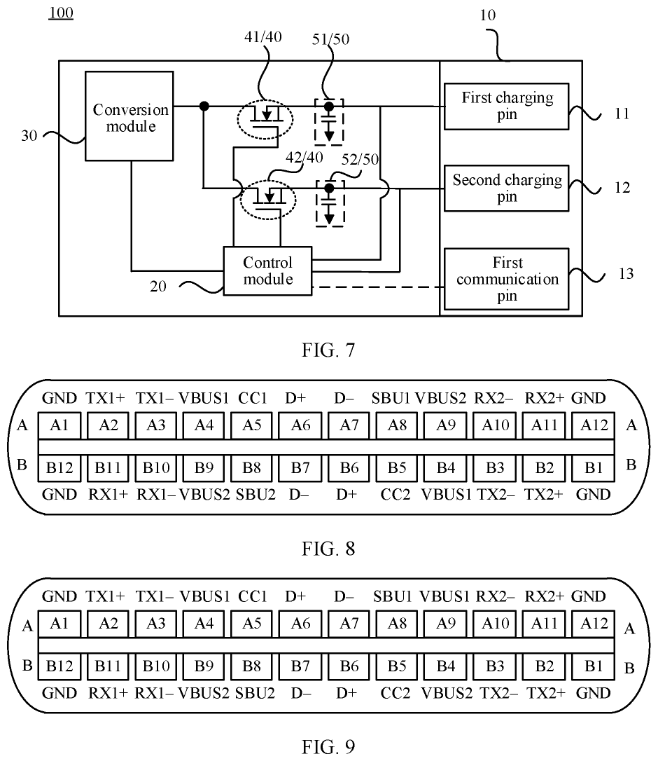

In addition, in order to make the power adapter 100 output a steady direct current, referring to FIG. 7, the power adapter 100 further includes two voltage filtering and regulation modules 50: a first voltage filtering and regulation module 51 and a second voltage filtering and regulation module 52. The first voltage filtering and regulation module 51 is electrically connected to the second end of the first switch tube 41. That is, the second voltage filtering and regulation module 52 is electrically connected to the second end of the second switch tube 42. By disposing the first voltage filtering and regulation module 51, the first power channel is enabled to transmit a steady direct current. By disposing the second voltage filtering and regulation module 52, the second power channel is enabled to transmit a steady direct current.

The type of the voltage filtering and regulation module 50 is not particularly limited herein, as long as the voltage filtering and regulation module enables the power adapter 100 to output a steady direct current. As an example, still referring to FIG. 7, the voltage filtering and regulation module 50 may be a capacitor. A first end of the capacitor is electrically connected to the second end of the switch tube, and a second end of the capacitor is grounded.

The structure of the conversion module 30 is not particularly limited herein, as long as the conversion module 30 can convert the alternating-current voltage output by the power supply 300 into a direct-current voltage. The conversion module 30 may be, for example, an AC-DC (Alternating Current-Direct Current) conversion circuit in the prior art. For a specific structure of the conversion circuit and the principles of converting an alternating current into a direct current, reference may be made to the technical solution in the prior art, details of which are omitted herein.

As for the type of the charging port 10, the type of the charging port 10 is not particularly limited herein. For example, the charging port may be a Type C port, or the like.

For a case in which the charging port 10 is a Type C port, the positions of pins of the charging port 10 are described below. The following examples do not constitute any limitation on this application.

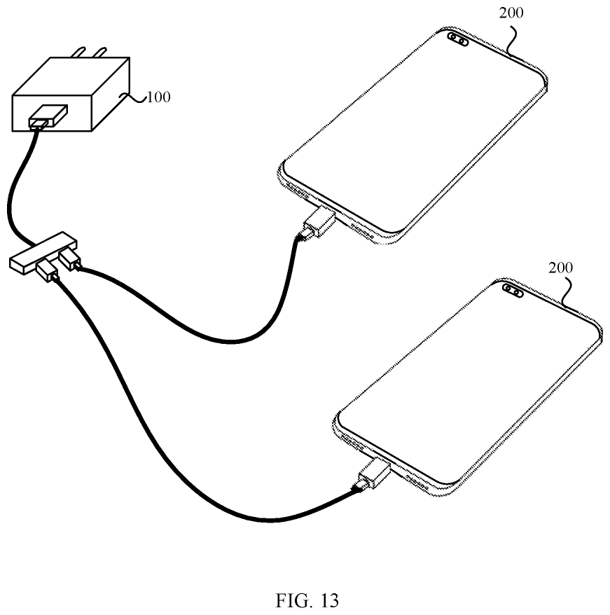

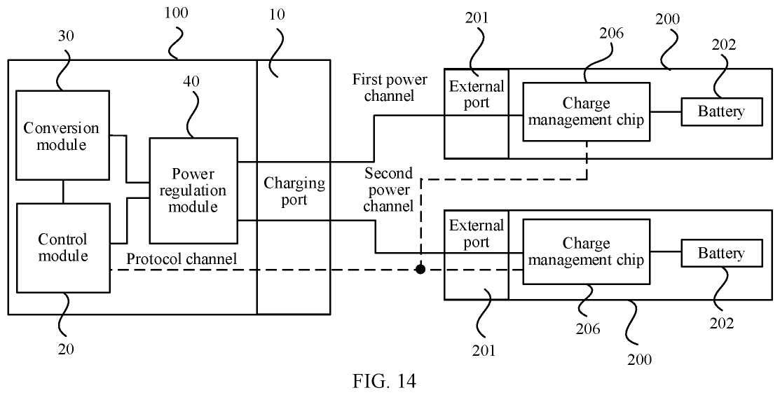

Referring to FIG. 8, when the charging port 10 is a Type C port, the charging port 10 include a surface A and a surface B. The surface A includes a VBUS1 pin (pin A4) and a VBUS2 pin (pin A9), and the surface B includes a VBUS2 pin (pin B9), and a VBUS1 pin (pin B4). The VBUS1 pin (pin A4) on the surface A is electrically connected to the VBUS1 pin (pin B4) on the surface B. The VBUS2 pin (pin A9) on the surface A is electrically connected to the VBUS1 pin (pin B4) on the surface B. The VBUS1 pin (pin A4) on the surface A and the VBUS1 pin (pin B4) on the surface B are first charging pins 11. The VBUS2 pin (pin A9) on the surface A and the VBUS1 pin (pin B4) on the surface B are second charging pins 12. Depending on the communication protocol, the following arrangements of pins are possible: (i) the D+ pins (pin A6 on the surface A and pin B6 on the surface B) and the D-pins (pin A7 on the surface A and pin B7 on the surface B) are first communication pins 13: (ii) the TX1+ pin (pin A2 on the surface A), the TX1− pin (pin A3 on the surface A), the TX2+ pin (pin B2 on the surface B), the TX2− pin (pin B3 on the surface B), the RX2+ pin (pin A11 on the surface A), RX2− pin (pin A10 on the surface A), the RX1+ pin (pin B11 on the surface B), and the RX1− pin (pin B10 on the surface B) are the first communication pins 13: (iii) the CC1 pin (pin A5 on the surface A) and the CC2 pin (pin B5 on the surface B) are the first communication pins 13: (iv) the D+ pins (pin A6 on the surface A and pin B6 on the surface B), the D− pins (pin A7 on the surface A and pin B7 on the surface B), the TX1+ pin (pin A2 on the surface A), the TX1− pin (pin A3 on the surface A), the TX2+ pin (pin B2 on the surface B), the TX2− pin (pin B3 on the surface B), the RX2+ pin (pin A11 on the surface A), the RX2− pin (pin A10 on the surface A), the RX1+ pin (pin B11 on the surface B), and the RX1− pin (pin B10 on the surface B) are the first communication pins 13: (v) the D+ pins (pin A6 on the surface A and pin B6 on the surface B) and the D− pins (pin A7 on the surface A and pin B7 on the surface B), the CC1 pin (pin A5 on the surface A), and the CC2 pin (pin B5 on the surface B) are the first communication pins 13: or, (vi) the TX1+ pin (pin A2 on the surface A), the TX1− pin (pin A3 on the surface A), the TX2+ pin (pin B2 on the surface B), the TX2− pin (pin B3 on the surface B), the RX2+ pin (pin A11 on the surface A), the RX2− pin (pin A10 on the surface A), the RX1+ pin (pin B11 on the surface B), the RX1− pin (pin B10 on the surface B), the CC1 pin (pin A5 on the surface A), and the CC2 pin (pin B5 on the surface B) are the first communication pins 13. The charging port 10 shown in FIG. 13 supports flexible insertion and reverse insertion of a power cable. The corresponding power channels of the first battery 203 and the second battery 204 in the mobile phone 200 can be connected correctly regardless of the insertion direction. The first power channel and the second power channel of the power adapter can match the batteries accurately without requiring a reverse insertion detection mechanism in the form of software or hardware, thereby greatly reducing the difficulty of implementation of software that discretely controls the first power channel and the second power channel.

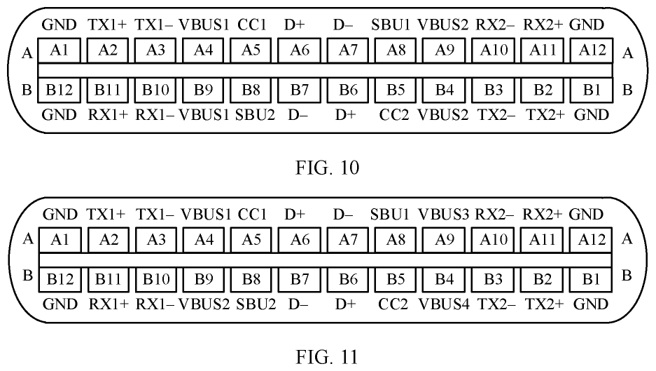

Referring to FIG. 9, different from FIG. 8, in FIG. 9, the surface A includes a VBUS1 pin (pin A4) and a VBUS1 pin (pin A9), and the surface B includes a VBUS2 pin (pin B9), and a VBUS2 pin (pin B4). The VBUS1 pin (pin A4) on the surface A is electrically connected to the VBUS2 pin (pin B9) on the surface B. The VBUS1 pin (pin A9) on the surface A is electrically connected to the VBUS2 pin (pin B4) on the surface B. The VBUS1 pin (pin A4) on the surface A and the VBUS2 pin (pin B9) on the surface B are the first charging pins 11. The VBUS1 pin (pin A9) on the surface A and the VBUS2 pin (pin B4) on the surface B are the second charging pins.

Referring to FIG. 10, different from FIG. 8, in FIG. 10, the surface A includes a VBUS1 pin (pin A4) and a VBUS1 pin (pin A9), and the surface B includes a VBUS1 pin (pin B9), and a VBUS2 pin (pin B4). The VBUS1 pin (pin A4) on the surface A is electrically connected to the VBUS1 pin (pin B4) on the surface B. The VBUS2 pin (pin A9) on the surface A is electrically connected to the VBUS2 pin (pin B4) on the surface B. The VBUS1 pin (pin A4) on the surface A and the VBUS1 pin (pin B4) on the surface B are first charging pins 11. The VBUS2 pin (pin A9) on the surface A and the VBUS2 pin (pin B4) on the surface B are the second charging pins 12.

Referring to FIG. 11, different from FIG. 8, in FIG. 11, the surface A includes a VBUS1 pin (pin A4) and a VBUS3 pin (pin A9), and the surface B includes a VBUS2 pin (pin B9), and a VBUS4 pin (pin B4). The VBUS1 pin (pin A4) on the surface A is electrically connected to the VBUS2 pin (pin B9) on the surface B. The VBUS3 pin (pin A9) on the surface A is electrically connected to the VBUS4 pin (pin B4) on the surface B. The VBUS1 pin (pin A4) on the surface A and the VBUS2 pin (pin B9) on the surface B are the first charging pins 11. The VBUS3 pin (pin A9) on the surface A and the VBUS4 pin (pin B4) on the surface B are the second charging pins 12.

In addition, the control module 20 not only serves the function of controlling the conversion module 30, the first switch tube 41, and the second switch tube 42, and the function of communicating with the mobile phone 200, but also serves conventional functions such as programmable circuit safety protection (against overvoltage, undervoltage, overcurrent, short circuit, overtemperature, and the like) and the function of parsing and processing a communication protocol. For the specific principles of such functions, reference may be made to the technical solutions in the prior art, and details of such functions are omitted herein.

The structure of the control module 20 is not particularly limited herein, as long as the control module 20 can implement the corresponding functions described in the above embodiment. The control module 20 may be, for example, a control chip. The control chip may be a single chip, or a combination of a plurality of chips.

As an example, the control module 20 includes a first control chip, a second control chip, and a third control chip. The first control chip is configured to control the first switch tube 41 and the second switch tube 42 to operate in the linear region or the saturation region, and monitor in real time the current and voltage transmitted on the first power channel and the second power channel. The second control chip is configured to communicate with the mobile phone 200. The third control chip is configured to protect the power adapter 100 against overvoltage, undervoltage, overcurrent, short circuits, and the like. In addition, when the first control chip is able to monitor in real time the current and voltage transmitted on the first power channel and the second power channel, other components such as a drive control unit (such as a constant-current/constant-voltage closed-loop regulator) or a digital-to-analog converter may be further disposed in the first control chip. The drive control unit (digital-to-analog converter) is configured to monitor in real time the current and voltage transmitted on the first power channel and the second power channel, compare the current and voltage with a preset current value and a preset voltage value, change the second control signal output to the switch tube, and in turn, change the operating region range of the switch tube. In this way, the switch tube is caused to work at an operating point in the linear region, and the voltage and current output by the switch tube are ensured to be the charging voltage and the charging current, respectively, required by the battery.

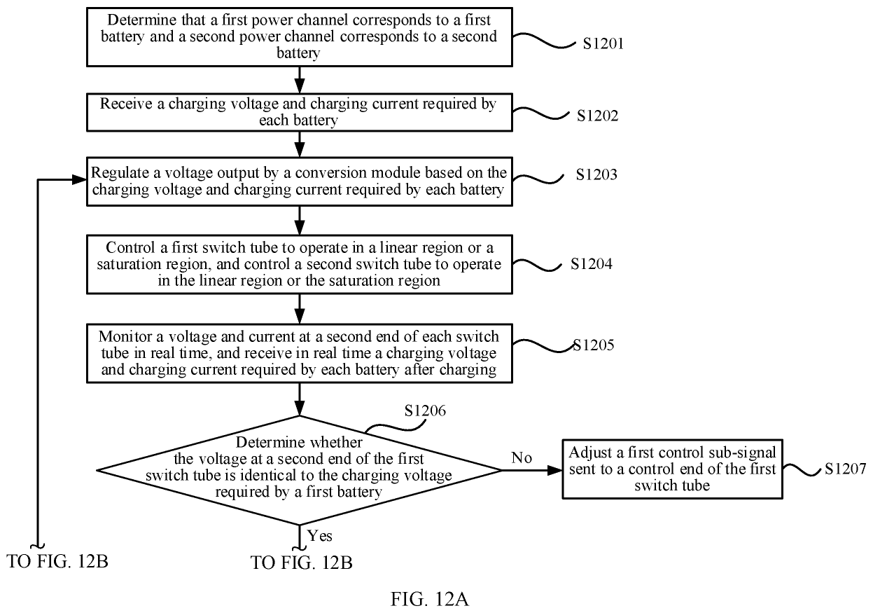

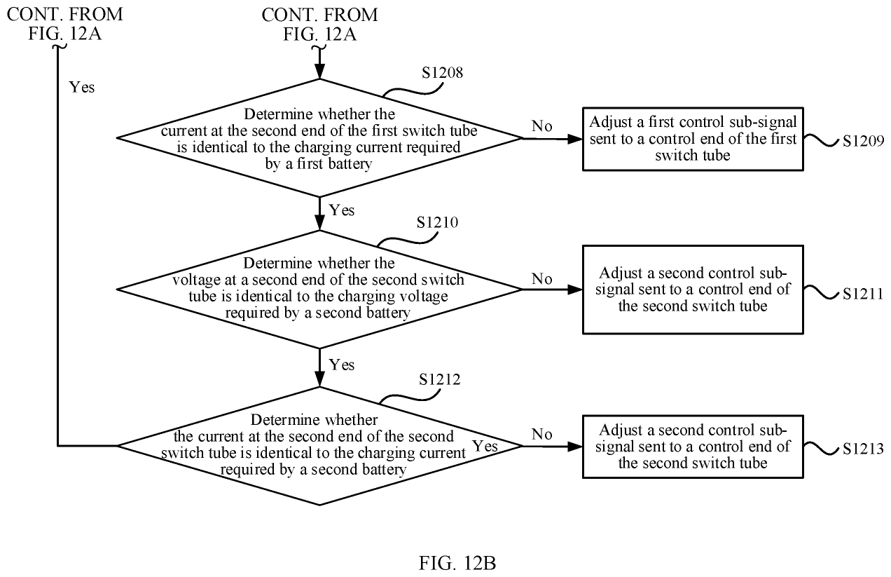

An embodiment of this application further provides a charging method. The charging method is applicable to the power adapter according to an embodiment of this application, for example. The beneficial effects of the charging method are the same as the beneficial effects brought by the power adapter according to this application. For details not described exhaustively in this embodiment, reference may be made to the embodiment of the power adapter above. The following describes the charging method with reference to the power adapter shown in FIG. 12A and FIG. 12B.

As shown in FIG. 12A and FIG. 12B, the charging method may be implemented in the following steps:

S1201. Determine that the power adapter is electrically connected to a mobile phone, and then increase voltage of a first power channel or a second power channel until it is determined that the first power channel corresponds to a first battery and the second power channel corresponds to a second battery.

For example, when determining that the power adapter 100 is connected to the mobile phone 200, a control module 20 controls a first switch tube 41 to operate in a saturation region and controls a second switch tube 42 to operate in a linear region based on a preset rule. As can be seen from above, when the first switch tube 41 operates in the saturation region, the current passing through the first switch tube 41 remains unchanged, and the on-resistance of the first switch tube 41 is tiny. The voltage of the first end is almost equal to the voltage of the second end of the first switch tube 41. When the second switch tube 42 operates in the linear region, the resistance of the second switch tube 42 is relatively large, and a voltage drop is generated when the current passes through the second switch tube 42. Therefore, the voltage at the second end of the second switch tube 42 is lower than the voltage at the first end of the second switch tube. In addition, the voltage at the first end of the first switch tube 41 is equal to the voltage at the first end of the second switch tube 42, and therefore, the voltage at the second end of the second switch tube 42 is lower than the voltage at the second end of the first switch tube 41. In this way, the voltage on the first power channel is higher than the voltage on the second power channel. The mobile phone 200 collects the voltage value on the first power channel. If the mobile phone 200 determines that the voltage on the first power channel is high enough, it indicates that the first power channel matches the first battery 203, and correspondingly, the second power channel matches the second battery 204. If the mobile phone 200 determines that the voltage on the first power channel is not higher than the voltage on the second power channel, it indicates that the first power channel does not match the first battery 203, and the second power channel does not match the second battery 204. The purpose of determining whether the power channels match the batteries is to prevent the first power channel from improperly corresponding to the second battery 204. The improper correspondence causes the first power channel to charge the second battery 204, and causes the second power channel to charge the first battery 203.

After the channel matching is completed, the mobile phone 200 sends the required charging power values (that is, a charging voltage value and a charging current value) of the first battery 203 and the second battery 204 to the control module 20 of the power adapter 100 through a protocol channel.

S1202. Receive the charging voltage value and charging current value required by the first battery as well as the charging voltage value and charging current value required by the second battery.

The control module 20 receives the charging voltage value and charging current value required by the first battery 203 as well as the charging voltage value and the charging current value required by the second battery 204, where the values are sent by the mobile phone 200.

S1203. Determine a maximum voltage value among the charging voltage value required by the first battery and the charging voltage value required by the second battery, and send a first control signal to the conversion module, so as to regulate a voltage output by the conversion module.

The control module 20 determines the charging voltage to be transmitted on each power channel. The control module 20 determines a maximum voltage value among the charging voltage value required by the first battery 203 and the charging voltage value required by the second battery 204, and, based on the maximum voltage, regulates the voltage output by the conversion module 30. The voltage output by the conversion module 30 may be identical to the maximum voltage value, or may be higher than the maximum voltage value. When the voltage output by the conversion module 30 is the maximum voltage among the charging voltage required by the first battery 203 and the charging voltage required by the second battery 204, one of the switch tubes can be made to operate in the saturation region, thereby reducing power consumption.

S1204. Determine, based on the voltage output by the conversion module and the charging voltage and charging current required by the first battery, a first control sub-signal sent to a control terminal of the first switch tube, so as to make the first switch tube operate in a linear region or a saturation region; and, determine, based on the voltage output by the conversion module and the charging voltage and charging current required by the second battery, a second control sub-signal sent to a control terminal of the second switch tube, so as to make the second switch tube operate in the linear region or saturation region.

When the first switch tube 41 operates in the saturation region or the linear region, the first power channel is turned on, and the voltage and current at the second end of the first switch tube 41 are transmitted to the first battery 203 by the first power channel to charge the first battery 203. When the second switch tube 42 operates in the saturation region or the linear region, the second power channel is turned on, and the voltage and current at the second end of the second switch tube 42 are transmitted to the second battery 204 by the second power channel to charge the second battery.

S1205. Monitor the voltage and current at the second end of the first switch tube and the voltage and current at the second end of the second switch tube in real time, and receive in real time a first regulation signal and a second regulation signal sent by the mobile phone, where the first regulation signal is a charging voltage and charging current required by the first battery after charging, and the second regulation signal is a charging voltage and charging current required by the second battery after charging.

In order to ensure accuracy of the current and voltage transmitted on the first power channel and the second power channel, where the accuracy means that the voltage and current on the first power channel are the charging current and charging voltage required by the first battery 203 and that the voltage and current on the second power channel are the charging current and charging voltage required by the second battery 204, During charging of the first battery 203 and the second battery 204, the control module 20 monitors in real time the current and voltage transmitted on the first power channel and the second power channel.

The mobile phone 200 collects the capacity value and state of charge value of the first battery 203 and the second battery 204 in real time, determines an amount of power to be added, and then, based on the amount of power to be added and the current voltage status of the battery, determines the charging power values required by the first battery 203 and the second battery 204, and sends the values to the control module 20 of the power adapter 100, where the charging power values are the voltage and current required for charging the first battery after charging as well as the voltage and current required for charging the second battery after charging.

S1206. Determine whether the voltage at the second end of the first switch tube is identical to the charging voltage required by the first battery; and, if the voltage at the second end of the first switch tube is different from the charging voltage required by the first battery, the process goes to step S1207: or, if the voltage at the second end of the first switch tube is identical to the charging voltage required by the first battery, the process goes to step S1208.

The control module 20 determines whether the voltage at the second end of the first switch tube 41 is identical to the charging voltage required by the first battery 203.

S1207. Adjust the first control sub-signal to make the voltage at the second end of the first switch tube equal to the charging voltage required by the first battery.

The control module 20 adjusts the first control sub-signal sent to the first switch tube 41, thereby changing the operating point of the first switch tube 41 in the linear region, and causing the voltage output by the first switch tube 41 to be the charging voltage required by the first battery 203.

S1208. Determine whether the current at the second end of the first switch tube is identical to the charging current required by the first battery; and, if the current at the second end of the first switch tube is different from the charging current required by the first battery, the process goes to step S1209: or, if the current at the second end of the first switch tube is identical to the charging current required by the first battery, the process goes to step S1210.

The control module 20 determines whether the current at the second end of the first switch tube 41 is identical to the charging current required by the first battery 203.

S1209. Adjust the first control sub-signal to make the current at the second end of the first switch tube equal to the charging current required by the first battery.

The control module 20 adjusts the first control sub-signal sent to the first switch tube 41, thereby changing the operating point of the first switch tube 41 in the linear region, and causing the current output by the first switch tube 41 to be the charging current required by the first battery 203.

S1210. Determine whether the voltage at the second end of the second switch tube is identical to the charging voltage required by the second battery; and, if the voltage at the second end of the second switch tube is different from the charging voltage required by the second battery, the process goes to step S1211; or, if the voltage at the second end of the second switch tube is identical to the charging voltage required by the second battery, the process goes to step S1212.

The control module 20 determines whether the voltage at the second end of the second switch tube 42 is identical to the charging voltage required by the second battery 204.

S1211. Adjust the second control sub-signal to make the voltage at the second end of the second switch tube equal to the charging voltage required by the second battery.

The control module 20 adjusts the second control sub-signal sent to the second switch tube 42, thereby changing the operating point of the second switch tube 42 in the linear region, and causing the voltage output by the second switch tube 42 to be the charging voltage required by the second battery 204.

S1212. Determine whether the current at the second end of the second switch tube is identical to the charging current required by the second battery; and, if the current at the second end of the second switch tube is different from the charging current required by the second battery, the process goes to step S1213: or, if the current at the second end of the second switch tube is identical to the charging current required by the second battery, return to step S1203 until completion of charging the first battery and the second battery.

The control module 20 determines whether the current at the second end of the second switch tube 42 is identical to the charging current required by the second battery 204.

S1213. Adjust the second control sub-signal to make the current at the second end of the second switch tube equal to the charging current required by the second battery.

The control module 20 adjusts the second control sub-signal sent to the second switch tube 42, thereby changing the operating point of the second switch tube 42 in the linear region, and causing the current output by the second switch tube 42 to be the charging current required by the second battery 204.

The mobile phone 200 collects the capacity value and state of charge value of the first battery 203 and the second battery 204 in real time, determines an amount of power to be added, and then, based on the amount of power to be added, determines the charging power values required by the first battery 203 and the second battery 204, and sends the values to the control module 20 of the power adapter 100, where the charging power values are the voltage and current required for charging the first battery after charging as well as the voltage and current required for charging the second battery after charging. Based on the charging power values required by the first battery 203 and second battery 204 at this time, the control module 20 redetermines a voltage to be transmitted on each power channel, and then determines a maximum voltage among all the voltages to be transmitted on different power channels, and then, based on the maximum voltage, regulates the voltage output by the conversion module 30. In addition, the control module 20 re-controls the first switch tube 41 to operate in the linear region or the saturation region, and re-controls the second switch tube 42 to operate in the linear region or the saturation region until completion of charging the first battery 203 and the second battery 204.

It is to be noted that the above example merely shows a process of a charging method, but without constituting any limitation on this application. For example, an alternative process may be: determining whether the voltage and current at the second end of the second switch tube 42 are equal to the charging voltage and charging current required by the second battery 204, and then determining whether the voltage and current at the second end of the first switch tube 41 are equal to the charging voltage and charging current required by the first battery 203. Another alternative process may be: determining whether the current at the second end of the first switch tube 41 is equal to the charging current required by the first battery 203, and then determining whether the voltage at the second end of the first switch tube 41 is equal to the charging voltage required by the first battery 203.

Understandably, the voltage at the second end of the first switch tube 41 is deemed to be identical to the charging voltage required by the first battery 203 as long as an error of the identicalness between the voltage at the second end of the first switch tube 41 and the charging voltage required by the first battery 203 falls within a specified range. The current at the second end of the first switch tube 41 is deemed to be identical to the charging current required by the first battery 203 as long as an error of the identicalness between the current at the second end of the first switch tube 41 and the charging current required by the first battery 203 falls within a specified range. The voltage at the second end of the second switch tube 42 is deemed to be identical to the charging voltage required by the second battery 204 as long as an error of the identicalness between the voltage at the second end of the second switch tube 42 and the charging voltage required by the second battery 204 falls within a specified range. The current at the second end of the second switch tube 42 is deemed to be identical to the charging current required by the second battery 204 as long as an error of the identicalness between the current at the second end of the second switch tube 42 and the charging current required by the second battery 204 falls within a specified range.

In addition, the charging method further includes:
determining a heat loss of the first switch module 41 based on the first control sub-signal and determining a heat loss of the second switch module 42 based on the second control sub-signal;
determining whether the heat loss of the first switch module 41 is greater than a preset heat loss value;
turning off the first switch tube 41 when the heat loss of the first switch module 41 is greater than the preset heat loss value; and, determining, when the heat loss of the first switch module 41 is less than or equal to the preset heat loss value, whether the heat loss of the second switch module 42 is greater than the preset heat loss value; and
turning off the second switch tube 42 when the heat loss of the second switch module 42 is greater than the preset heat loss value.

Additionally or alternatively,
a temperature sensor (not shown in the drawing) is disposed in the power adapter 200. The temperature sensor collects the temperature value of the first switch tube 41 and the second switch tube 42 in real time, and sends the collected temperature values of the first switch tube 41 and the second switch tube 42 to the control module 20.

In this case, the charging method further includes:
determining whether the temperature value of the first switch module 41 is higher than a preset temperature value;
turning off the first switch tube 41 when the temperature of the first switch module 41 is greater than the preset temperature value; and, determining, when the temperature of the first switch module 41 is less than or equal to the preset temperature value, whether the temperature of the second switch module 42 is greater than the preset temperature value; and
turning off the second switch tube 42 when the temperature of the second switch module 42 is greater than the preset temperature value.

In this way, a high heat loss is prevented from damaging the first switch tube 41 and the second switch tube 42, and the first switch tube 41 and the second switch tube 42 are protected.

In summary, for a scenario in which a power adapter 100 charges a plurality of batteries 203 in a mobile phone 200 through one charging port 10: in contrast to the practice of disposing the power regulation module 40 in the mobile phone, the above technical solution disposes the power regulation module 40 in the power adapter 100, thereby reducing the designed area of a mainboard of the mobile phone 200, and facilitating placement of other structures inside the mobile phone 200. In addition, because the first switch tube 41 and the second switch tube 42 can regulate the charging voltage and charging current, the voltage and state of charge of the first battery 203 are equal to those of the second battery 204 after completion of charging. In this way, when the first battery 203 and the second battery 204 are discharged in parallel, energy exchange is avoided between the first battery 203 and the second battery 204 (for example, that the battery with a higher voltage and a higher state of charge feeds voltage to the battery with a lower voltage and a lower state of charge is avoided). In the conventional practice, the switch tube 205 is disposed inside the mobile phone 200, the discharging is performed through the switch tube 205 during the charging to make the voltage and state of charge equal between the two batteries. Compared with the conventional practice, this application alleviates the problem of heating of the mobile phone 200. In addition, the charging current and the charging voltage transmitted on each channel can be regulated just by controlling the first switch tube 41 to operate in the saturation region or the linear region and controlling the second switch tube 42 to operate in the saturation region or the linear region, without a need to dispose a complicated circuit structure, thereby reducing the cost of the power adapter 100, reducing the size of the power adapter 100, and improving charging energy efficiency. Moreover, the charging voltage and the charging current transmitted on each power channel can be flexibly controlled. Therefore, the power adapter 100 according to this embodiment of this application is prominently superior in charging a multi-battery mobile phone in which the capacity is highly unequal between the batteries, thereby providing better user experience in charging a multi-battery mobile phone.

### Scenario II

Referring to FIG. 13 and FIG. 14, FIG. 13 and FIG. 14 are schematic diagrams of another application scenario of a power adapter according to an embodiment of this application. The structure of the power adapter 100 is identical to that described in the above example (FIG. 4), details of which are omitted here. The difference from the preceding example is that the power adapter 100 charges batteries 202 in at least two mobile phones 200 through a single charging port 10. The number of batteries 203 in each mobile phone 200 is one. FIG. 13 and FIG. 14 illustrate an example in which the power adapter 100 charges the batteries 203 in two mobile phones 200 through a single charging port. The two mobile phones 200 are a first mobile phone 208 and a second mobile phone 209 respectively. The power adapter 100 is electrically connected to the first mobile phone 208 and the second mobile phone 209 by one charging port 10. To be specific, in this application scenario, the power adapter 100 charges the batteries 202 in the two mobile phones 200 (the first mobile phone 208 and the second mobile phone 209) through one charging port 10.

It is to be noted that explanations of the terms identical or equivalent to the terms in the above embodiments are omitted here.

The following describes the charging principles of the power adapter 100 in the above scenario in detail.

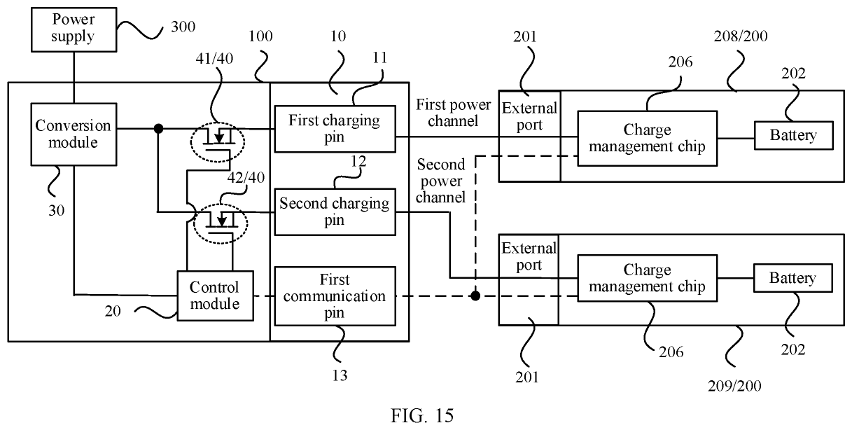

Referring to FIG. 15, when the power adapter 100 needs to charge the first mobile phone 208 and the second mobile phone 209, one end of the power adapter 100 is electrically connected to the power supply 300, and the other end of the power adapter is electrically connected to the mobile phone 200. That is, the input end of the conversion module 30 of the power adapter 100 is electrically connected to the power supply 300, and the power adapter 100 is electrically connected to the first mobile phone 208 and the second mobile phone 209 separately by the charging port 10. The external port 201 of the first mobile phone 208 is electrically connected to the first charging pin 11 and the first communication pin 13 to implement electrical connection between the power adapter 100 and the first mobile phone 208. The external port 201 of the second mobile phone 209 is electrically connected to the second charging pin 12 and the first communication pin 13 to implement electrical connection between the power adapter 100 and the second mobile phone 209. A path formed by the output end of the first switch tube 41, the first charging pin 11, the external port 201 of the first mobile phone 208, and a charge management chip 206 is a first power channel. A path formed by the output end of the second switch tube 42, the second charging pin 12, the external port 201 of the second mobile phone 209, and the charge management chip 206 is a second power channel. A path formed by the first communication pin 13 and the external port 201 of the first mobile phone 208 is a protocol channel of the first mobile phone 208. A path formed by the first communication pin 13 and the external port 201 of the second mobile phone 209 is a protocol channel of the second mobile phone 209.

Specifically, when the power adapter 100 or the first mobile phone 208 and the second mobile phone 209 detect that the power adapter 100 is connected to the first mobile phone 208 or the second mobile phone 209, the first mobile phone 208 transmits a communication protocol through a protocol channel to implement a protocol handshake and determine the status of matching between the power adapter 100 and the first power channel of the first mobile phone 208. In addition, the second mobile phone 209 transmits a communication protocol through a protocol channel to implement a protocol handshake and determine the status of matching between the power adapter 100 and the second power channel of the second mobile phone 209. In other words, the second mobile phone determines whether the first power channel corresponds to the battery 203 in the first mobile phone 208 and whether the second power channel corresponds to the battery 203 in the second mobile phone 209.

It is hereby noted that the method of how the power adapter 100 or the first mobile phone 208 or the second mobile phone 209 detects connection of the power adapter 100 to the first mobile phone 208 or the second mobile phone 209 is not limited in this embodiment of this application. For example, when a level change is detected on the external port 201, the first mobile phone 208 determines that the power adapter 100 is connected to the first mobile phone 208. When a level change is detected on the external port 201, the second mobile phone 209 determines that the power adapter 100 is connected to the second mobile phone 209.

In addition, the method for determining whether the power channels between the power adapter 100 and the mobile phone 200 match the batteries is not limited in this embodiment of this application. For example, when it is detected that the power adapter 100 is connected to the first mobile phone 208 and the second mobile phone 209, a control module 20 turns on a first switch tube 41 and turns off a second switch tube 42 based on a preset rule. The first mobile phone 208 collects the voltage value on the first power channel. If the first mobile phone 208 determines that a voltage is transmitted on the first power channel, it indicates that the first power channel matches the first mobile phone 208, and the control module turns on the second switch tube 42 and turns off the first switch tube 41. The second mobile phone 209 collects the voltage value on the second power channel. If the second mobile phone 209 determines that a voltage is transmitted on the second power channel, it indicates that the second power channel matches the second mobile phone 209, In this way, the first power channel is prevented from improperly corresponding to the second mobile phone 209, and the second power channel is prevented from improperly corresponding to the first mobile phone 208. The improper correspondence causes the first power channel to charge the battery 202 in the second mobile phone 209, and causes the second power channel to charge the battery 202 in the first mobile phone 208.

After the channel matching is completed, the first mobile phone 208 sends the required charging power values (that is, a charging voltage value and a charging current value required by the battery 203) of the battery 203 to the control module 20 of the power adapter 100 through a protocol channel. The second mobile phone 209 sends the required charging power values (that is, a charging voltage value and a charging current value required by the battery 203) of the battery 203 to the control module 20 of the power adapter 100 through a protocol channel. Based on the charging voltage value and charging current value required by the first mobile phone 208 and the charging voltage value and charging current value required by the second mobile phone 209, the control module 20 determines that the first power channel needs to transmit the charging voltage required by the first mobile phone 208, and determines that the second power channel needs to transmit the charging voltage required by the second mobile phone 209.

Due to differences in the factors such as capacity and state of charge between the first mobile phone 208 and the second mobile phone 209, the charging voltage required by the first mobile phone 208 is generally different from the charging voltage required by the second mobile phone 209. The control module 20 determines a maximum voltage value among the charging voltage value required by the first mobile phone 208 and the charging voltage value required by the second mobile phone 209, and sends a first control signal to the conversion module 30 based on the required maximum voltage value. The conversion module 30 regulates the output voltage of the conversion module based on the first control signal, so that the output voltage can meet the charging voltages required by different power channels. The voltage output by the conversion module 30 may be identical to the maximum voltage value, or may be higher than the maximum voltage value. As an example, when the charging voltage required by the first mobile phone 208 is 10 V, the charging voltage required by the second mobile phone 209 is 9.5 V. The voltage can meet the required charging voltages of different channels as long as the voltage output by the conversion module 30 is greater than or equal to 10 V. Therefore, if the output voltage of the conversion module 30 is, for example, 9.8 V, the output voltage fails to meet the charging voltage required by the first power channel.

When the voltage output by the conversion module 30 is the maximum voltage value among the charging voltage required by the first mobile phone 208 and the charging voltage required by the second mobile phone 209, that is, when the output voltage is 10 V, the control module 20 controls, through the first control sub-signal output to the control end of the first switch tube 41, the first switch tube 41 to operate in the saturation region, so that the voltage on the first power channel is 10 V. The control module controls the second switch tube 42 to operate in the linear region through the second control sub-signal output to the control end of the second switch tube 42, so that the voltage on the second power channel is 9.5 V. That is because the charging voltage required by the first mobile phone 208 is 10 V. When the first switch tube 41 operates in the saturation region, the voltage at the first end of the first switch tube 41 is identical to the voltage at the second end of the first switch tube. Therefore, the voltage transmitted on the first power channel is the charging voltage 10 V required by the first mobile phone 208. However, the charging voltage required by the second mobile phone 209 is 9.5 V. When the second switch tube 42 operates in the linear region, the second switch tube 42 is equivalent to a resistor. A voltage drop occurs after the voltage passes through the second switch tube 42. In this way, the voltage at the second end of the second switch tube 42 is decreased to 9.5 V. In other words, by adjusting the second control sub-signal at the control end of the second switch tube 42, the resistance value of the second switch tube 42 in the variable resistance region (also a linear region) is adjusted, thereby adjusting the voltage and current at the second end of the second switch tube 42, and causing the voltage and current to be the charging voltage and the charging current required by the second mobile phone 209. In this way, the charging voltage and charging current are allocated to the first power channel and the second power channel, thereby enabling fast charging for the first mobile phone 208 and the second mobile phone 209.

In addition, the first mobile phone 208 collects the capacity value and state of charge value of the internal battery 203 in real time, determines an amount of power to be added, and then, based on the amount of power to be added and the current voltage status of the battery, determines the charging voltage value and the charging current value required by the battery 203 at this time, and sends the values to the control module 20 of the power adapter 100. In addition, the second mobile phone 209 collects the capacity value and state of charge value of the internal battery 203 in real time, determines an amount of power to be added, and then, based on the amount of power to be added and the current voltage status of the battery, determines the charging voltage value and the charging current value required by the battery 203 at this time, and sends the values to the control module 20 of the power adapter 100. Based on the charging power values required by the battery 203 in the first mobile phone 208 and the battery 203 in the second mobile phone 209 at this time, the control module 20 redetermines a charging voltage to be transmitted on the first power channel and required for charging the first mobile phone 208, and redetermines a charging voltage to be transmitted on the second power channel and required for charging the second mobile phone 209. Subsequently, based on the charging voltages to be transmitted by different power channels, the control module determines a maximum charging voltage required, and, based on the maximum voltage, regulates the voltage output by the conversion module 30, so that the output voltage of the conversion module 30 meets the required charging voltages of different channels. In addition, the control module 20 re-controls the first switch tube 41 to operate in the linear region or the saturation region, and re-controls the second switch tube 42 to operate in the linear region or the saturation region. The specific principles are the same as the process described above, and are omitted here.

In addition, during the charging, the first mobile phone 208 monitors in real time whether the state of charge (SOC) of the internal battery 203 reaches a preset SOC (for example, 100% SOC). When the SOC of the internal battery 203 of the first mobile phone 208 reaches the preset SOC, the first mobile phone sends a charging-completed message to the control module 20 through a protocol channel. The control module 20 turns off the first switch tube 41 based on the charging-completed message. The second mobile phone 209 monitors in real time whether the state of charge (SOC) of the internal battery 203 reaches a preset SOC (for example, 100% SOC). When the SOC of the internal battery 203 of the second mobile phone 209 reaches the preset SOC, the second mobile phone sends a charging-completed message to the control module 20 through a protocol channel. The control module 20 turns off the second switch tube 42 based on the charging-completed message.

It is to be noted that, in a case that the power adapter 100 can charge two mobile phones 200 separately, the specific structure and batteries of the mobile phone 200 are not particularly limited herein. In other words, regardless of the specific structure inside the mobile phone 200, the power adapter 100 can charge a plurality of mobile phones 200. The mobile phones are not limited to the mobile phone 200 shown in FIG. 14.

In addition, in this embodiment, the heat loss of the first switch tube 41 and the second switch tube 42 also needs to be monitored in real time. The specific monitoring steps are the same as those in the above embodiment. Reference may be made to the above embodiment, and details are omitted here.

In addition, when the charging power of the first mobile phone 208 is different from the charging power of the second mobile phone 209, that is, when the voltage and current transmitted on the first power channel are different from those transmitted on the second power channel, in order to alleviate the severe heating of the switch tube operating in the linear region and enhance the energy efficiency, the operating mode of the switch tube corresponding to one of the mobile phones 200 may be set to an on-off mode, that is, intermittently on and off. In a case of turning on the switch tube, the switch tube may be turned on in a saturation manner or a linear manner. The operating mode of the switch tube corresponding to the other mobile phone 200 is a normally-on mode, and this switch tube may operate in the saturation region or linear region. In this way, the switch tube turned on intermittently can alleviate self-heating by operating intermittently. When the switch tube turned on intermittently is turned off, if the switch tube working in a normally open mode operates in the linear region at this time, the output voltage of the conversion module 30 can be changed by the control module 20 to cause the switch tube to operate in the saturation region, thereby alleviating the heating of the switch tube and improving energy efficiency.

In addition, the first mobile phone 208 monitors the status of the internal battery 203 in real time. When determining that the battery 203 is damaged, the first mobile phone sends a turn-off message to the control module 20 through the protocol channel, where the turn-off message is an instruction to turn off the switch tube corresponding to the damaged battery. Based on the turn-off message, the control module 20 turns off the switch tube. The second mobile phone 209 monitors the status of the internal battery 203 in real time. When determining that the battery 203 is damaged, the second mobile phone sends a turn-off message to the control module 20 through the protocol channel, where the turn-off message is an instruction to turn off the switch tube corresponding to the damaged battery. Based on the turn-off message, the control module 20 turns off the switch tube. In this way, the faulty battery can be automatically isolated by controlling the on and off states of the switch tube, and the method is simple.

In addition, in order to ensure accuracy of the current and voltage transmitted on the first power channel and the second power channel, where the accuracy means that the voltage and current on the first power channel are the charging current and charging voltage required by the first mobile phone 208 and that the voltage and current on the second power channel are the charging current and charging voltage required by the second mobile phone 209, the second end of the first switch tube 41 and the second end of the second switch tube 42 are electrically connected to the control module 20 separately. The specific connection manner and principles are the same as those in the above example (FIG. 6). Reference may be made to the above embodiment, and details are omitted here.

In addition, a voltage filtering and regulation module 50 is also disposed in this embodiment. The location, purposes, and type of the voltage filtering and regulation module 50 are the same as those in the above example (FIG. 7). Reference may be made to the above embodiment, and details are omitted here.

The specific structures and functions of the control module 20 and the conversion module 30 are the same as those in the above example. Reference may be made to the above embodiment, and details are omitted here.

The type of the charging port 10, the pinout of the internal pins of the charging port, and the like are the same as those in the above example. Reference may be made to the above embodiment, and details are omitted here.

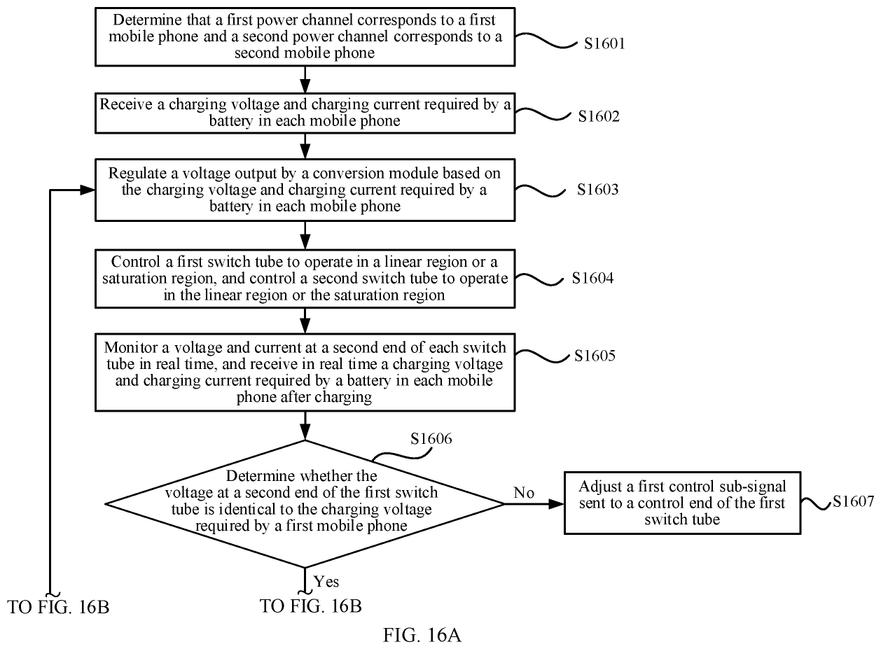

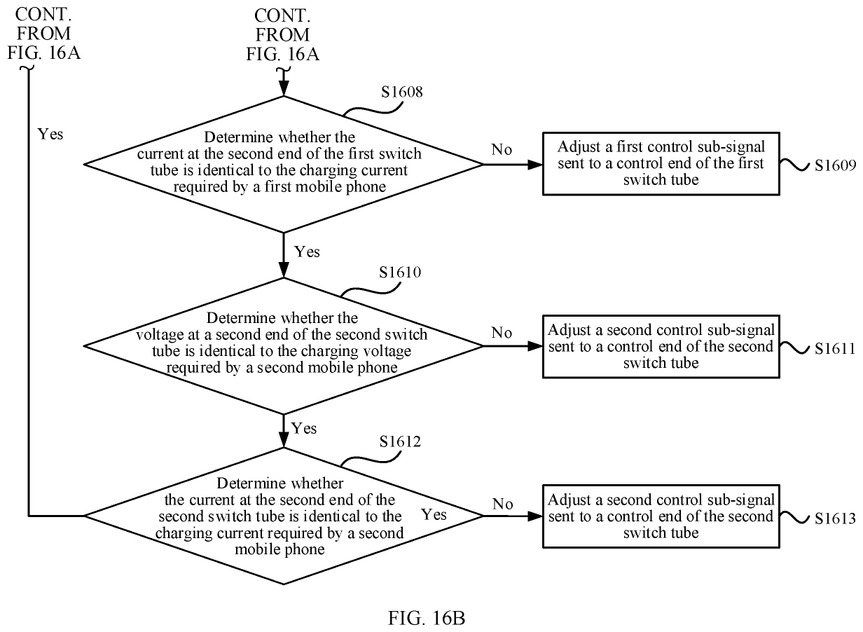

An embodiment of this application further provides a charging method. The charging method is applicable to the power adapter according to an embodiment of this application, for example. The beneficial effects of the charging method are the same as the beneficial effects brought by the power adapter according to this application. For details not described exhaustively in this embodiment, reference may be made to the embodiment of the power adapter above. The following describes the charging method with reference to the power adapter shown in FIG. 16A and FIG. 16B.

As shown in FIG. 16A and FIG. 16B, the charging method may be implemented in the following steps:

S1601. Electrically connect a power adapter to a first mobile phone and a second mobile phone, and then increase voltage of a first power channel or a second power channel until it is determined that the first power channel corresponds to the first mobile phone and the second power channel corresponds to the second mobile phone.

When it is determined that the power adapter 100 is connected to the first mobile phone 208 and the second mobile phone 209, a control module 20 turns on a first switch tube 41 and turns off a second switch tube 42 based on a preset rule. The first mobile phone 208 collects the voltage value on the first power channel. If the first mobile phone 208 determines that a voltage is transmitted on the first power channel, it indicates that the first power channel matches the first mobile phone 208, and the control module turns on the second switch tube 42 and turns off the first switch tube 41. The second mobile phone 209 collects the voltage value on the second power channel. If the second mobile phone 209 determines that a voltage is transmitted on the second power channel, it indicates that the second power channel matches the second mobile phone 209, In this way, the first power channel is prevented from improperly corresponding to the second mobile phone 209, and the second power channel is prevented from improperly corresponding to the first mobile phone 208. The improper correspondence causes the first power channel to charge the second mobile phone 209, and causes the second power channel to charge the first mobile phone 208.

After the channel matching is completed, the first mobile phone 208 sends the required charging power values (that is, a charging voltage value and a charging current value required by the battery 203) of the battery 203 to the control module 20 of the power adapter 100 through a protocol channel. The second mobile phone 209 sends the required charging power values (that is, a charging voltage value and a charging current value required by the battery 203) of the battery 203 to the control module 20 of the power adapter 100 through a protocol channel.

S1602. Receive the charging voltage value and charging current value required by the battery in the first mobile phone as well as the charging voltage value and charging current value required by the battery in the second mobile phone.

The control module 20 receives the charging voltage value and charging current value required by the internal battery 203 and sent by the first mobile phone 208, and receives the charging voltage value and the charging current value required by the internal battery 203 and sent by the second mobile phone 209.

S1603. Determine a maximum voltage value among the charging voltage value required by the battery in the first mobile phone and the charging voltage value required by the battery in the second mobile phone, and send a first control signal to the conversion module, so as to regulate a voltage output by the conversion module.

The control module 20 determines the charging voltage to be transmitted on each power channel. The control module 20 determines a maximum voltage value among the charging voltage value required by the internal battery 203 and sent by the first mobile phone 208 as well as the charging voltage value required by the internal battery 203 and sent by the second mobile phone 209, and, based on the maximum voltage, regulates the voltage output by the conversion module 30. The voltage output by the conversion module 30 may be identical to the maximum voltage value, or may be higher than the maximum voltage value. When the voltage output by the conversion module 30 is the maximum voltage among the charging voltage required by the battery 203 in the first mobile phone 208 and the charging voltage required by the battery 203 in the second mobile phone 209, one of the switch tubes can be made to operate in the saturation region, thereby reducing power consumption.

S1604. Determine, based on the voltage output by the conversion module and the charging voltage and charging current required by the battery 203 in the first mobile phone 208, a first control sub-signal sent to a control terminal of the first switch tube, so as to make the first switch tube operate in a linear region or a saturation region; and, determine, based on the voltage output by the conversion module and the charging voltage and charging current required by the battery 203 in the second mobile phone 209, a second control sub-signal sent to a control terminal of the second switch tube, so as to make the second switch tube operate in the linear region or saturation region.

When the first switch tube 41 operates in the saturation region or the linear region, the first power channel is turned on, and the voltage and current at the second end of the first switch tube 41 are transmitted to the battery 203 in the first mobile phone 208 by the first power channel to charge the battery 203 in the first mobile phone 208. When the second switch tube 42 operates in the saturation region or the linear region, the second power channel is turned on, and the voltage and current at the second end of the second switch tube 42 are transmitted to the battery 203 in the second mobile phone 209 by the second power channel to charge the battery 203 in the second mobile phone 209.

S1605. Monitor the voltage and current at the second end of the first switch tube and the voltage and current at the second end of the second switch tube in real time, and receive in real time a first regulation signal and a second regulation signal sent by the mobile phone, where the first regulation signal is a charging voltage and charging current required by the battery 203 in the first mobile phone 208 after charging, and the second regulation signal is a charging voltage and charging current required by the battery 203 in the second mobile phone 209 after charging.

In order to ensure accuracy of the current and voltage transmitted on the first power channel and the second power channel, where the accuracy means that the voltage and current on the first power channel are the charging current and charging voltage required by the battery 203 in the first mobile phone 208 and that the voltage and current on the second power channel are the charging current and charging voltage required by the battery 203 in the second mobile phone 209, During charging of the battery 203 in the first mobile phone 208 and the battery 203 in the second mobile phone 209, the control module 20 monitors in real time the current and voltage transmitted on the first power channel and the second power channel.

The first mobile phone 208 collects the capacity value and state of charge value of the battery 203 in the first mobile phone 208 in real time, determines an amount of power to be added, and then, based on the amount of power to be added and the current voltage status of the battery, determines the charging power value required by the battery 203 in the first mobile phone 208, and sends the value to the control module 20 of the power adapter 100, where the charging power value is the voltage and current required for charging the battery 203 in the first mobile phone 208 after charging.

The second mobile phone 209 collects the capacity value and state of charge value of the battery 203 in the second mobile phone 209 in real time, determines an amount of power to be added, and then, based on the amount of power to be added and the current voltage status of the battery, determines the charging power value required by the battery 203 in the second mobile phone 209, and sends the value to the control module 20 of the power adapter 100, where the charging power value is the voltage and current required for charging the battery 203 in the second mobile phone 209 after charging.

S1606. Determine whether the voltage at the second end of the first switch tube is identical to the charging voltage required by the battery in the first mobile phone; and, if the voltage at the second end of the first switch tube is different from the charging voltage required by the battery in the first mobile phone, the process goes to step S1607; or, if the voltage at the second end of the first switch tube is identical to the charging voltage required by the battery in the first mobile phone, the process goes to step S1608.

The control module 20 determines whether the voltage at the second end of the first switch tube 41 is identical to the charging voltage required by the battery 203 in the first mobile phone 208.

S1607. Adjust the first control sub-signal to make the voltage at the second end of the first switch tube equal to the charging voltage required by the battery in the first mobile phone.

The control module 20 adjusts the first control sub-signal sent to the first switch tube 41, thereby changing the operating point of the first switch tube 41 in the linear region, and causing the voltage output by the first switch tube 41 to be the charging voltage required by the battery 203 in the first mobile phone 208.

S1608. Determine whether the current at the second end of the first switch tube is identical to the charging current required by the battery in the first mobile phone; and, if the current at the second end of the first switch tube is different from the charging current required by the battery in the first mobile phone, the process goes to step S1609; or, if the current at the second end of the first switch tube is identical to the charging current required by the battery in the first mobile phone, the process goes to step S1610.

The control module 20 determines whether the current at the second end of the first switch tube 41 is identical to the charging current required by the battery 203 in the first mobile phone 208.

S1609. Adjust the first control sub-signal to make the current at the second end of the first switch tube equal to the charging current required by the battery in the first mobile phone.

The control module 20 adjusts the first control sub-signal sent to the first switch tube 41, thereby changing the operating point of the first switch tube 41 in the linear region, and causing the current output by the first switch tube 41 to be the charging current required by the battery 203 in the first mobile phone 208.

S1610. Determine whether the voltage at the second end of the second switch tube is identical to the charging voltage required by the battery in the second mobile phone; and, if the voltage at the second end of the second switch tube is different from the charging voltage required by the battery in the second mobile phone, the process goes to step S1611: or, if the voltage at the second end of the second switch tube is identical to the charging voltage required by the battery in the second mobile phone, the process goes to step S1612.

The control module 20 determines whether the voltage at the second end of the second switch tube 42 is identical to the charging voltage required by the battery 203 in the second mobile phone 209.

S1611. Adjust the second control sub-signal to make the voltage at the second end of the second switch tube equal to the charging voltage required by the battery in the second mobile phone.

The control module 20 adjusts the second control sub-signal sent to the second switch tube 42, thereby changing the operating point of the second switch tube 42 in the linear region, and causing the voltage output by the second switch tube 42 to be the charging voltage required by the battery 203 in the second mobile phone 209.

S1612. Determine whether the current at the second end of the second switch tube is identical to the charging current required by the battery in the second mobile phone; and, if the current at the second end of the second switch tube is different from the charging current required by the battery in the second mobile phone, the process goes to step S1613: or, if the current at the second end of the second switch tube is identical to the charging current required by the second battery, return to step S1603 until completion of charging the battery in the first mobile phone and the battery in the second mobile phone.

The control module 20 determines whether the current at the second end of the second switch tube 42 is identical to the charging current required by the battery 203 in the second mobile phone 209.

S1613. Adjust the second control sub-signal to make the current at the second end of the second switch tube equal to the charging current required by the battery in the second mobile phone.

The control module 20 adjusts the second control sub-signal sent to the second switch tube 42, thereby changing the operating point of the second switch tube 42 in the linear region, and causing the current output by the second switch tube 42 to be the charging current required by the battery 203 in the second mobile phone 209.

The mobile phone 200 collects the capacity value and state of charge value of the battery 203 in the first mobile phone 208 and the battery 203 in the second mobile phone 209 in real time, determines an amount of power to be added, and then, based on the amount of power to be added, determines the charging power values required by the battery 203 in the first mobile phone 208 and the battery 203 in the second mobile phone 209, and sends the values to the control module 20 of the power adapter 100, where the charging power values are the voltage and current required for charging the battery 203 in the first mobile phone 208 after charging as well as the voltage and current required for charging the battery 203 in the second mobile phone 209 after charging. Based on the charging power values required by the battery 203 in the first mobile phone 208 and the battery 203 in the second mobile phone 209 at this time, the control module 20 redetermines a voltage to be transmitted on each power channel, and then determines a maximum voltage among all the voltages to be transmitted on different power channels, and then, based on the maximum voltage, regulates the voltage output by the conversion module 30. In addition, the control module 20 re-controls the first switch tube 41 to operate in the linear region or the saturation region, and re-controls the second switch tube 42 to operate in the linear region or the saturation region until completion of charging the battery 203 in the first mobile phone 208 and the battery 203 in the second mobile phone 209.

It is to be noted that the above example merely shows a process of a charging method, but without constituting any limitation on this application. For example, an alternative process may be: determining whether the voltage and current at the second end of the second switch tube 42 are equal to the charging voltage and charging current required by the battery 203 in the second mobile phone 209, and then determining whether the voltage and current at the second end of the first switch tube 41 are equal to the charging voltage and charging current required by the battery 203 in the first mobile phone 208. Another alternative process may be: determining whether the current at the second end of the first switch tube 41 is equal to the charging current required by the battery 203 in the first mobile phone 208, and then determining whether the voltage at the second end of the first switch tube 41 is equal to the charging voltage required by the battery 203 in the first mobile phone 208.

Understandably, the voltage at the second end of the first switch tube 41 is deemed to be identical to the charging voltage required by the battery 203 in the first mobile phone 208 as long as an error of the identicalness between the voltage at the second end of the first switch tube 41 and the charging voltage required by the battery 203 in the first mobile phone 208 falls within a specified range. The current at the second end of the first switch tube 41 is deemed to be identical to the charging current required by the battery 203 in the first mobile phone 208 as long as an error of the identicalness between the current at the second end of the first switch tube 41 and the charging current required by the battery 203 in the first mobile phone 208 falls within a specified range. The voltage at the second end of the second switch tube 42 is deemed to be identical to the charging voltage required by the battery 203 in the second mobile phone 209 as long as an error of the identicalness between the voltage at the second end of the second switch tube 42 and the charging voltage required by the battery 203 in the second mobile phone 209 falls within a specified range. The current at the second end of the second switch tube 42 is deemed to be identical to the charging current required by the battery 203 in the second mobile phone 209 as long as an error of the identicalness between the current at the second end of the second switch tube 42 and the charging current required by the battery 203 in the second mobile phone 209 falls within a specified range.

In addition, the charging method further includes:
determining a heat loss of the first switch module 41 based on the first control sub-signal and determining a heat loss of the second switch module 42 based on the second control sub-signal;
determining whether the heat loss of the first switch module 41 is greater than a preset heat loss value;
turning off the first switch tube 41 when the heat loss of the first switch module 41 is greater than the preset heat loss value; and, determining, when the heat loss of the first switch module 41 is less than or equal to the preset heat loss value, whether the heat loss of the second switch module 42 is greater than the preset heat loss value; and
turning off the second switch tube 42 when the heat loss of the second switch module 42 is greater than the preset heat loss value.

Additionally or alternatively, a temperature sensor (not shown in the drawing) is disposed in the power adapter 200. The temperature sensor collects the temperature value of the first switch tube 41 and the second switch tube 42 in real time, and sends the collected temperature values of the first switch tube 41 and the second switch tube 42 to the control module 20.

In this case, the charging method further includes:
determining whether the temperature value of the first switch module 41 is higher than a preset temperature value;
turning off the first switch tube 41 when the temperature of the first switch module 41 is greater than the preset temperature value; and, determining, when the temperature of the first switch module 41 is less than or equal to the preset temperature value, whether the temperature of the second switch module 42 is greater than the preset temperature value; and
turning off the second switch tube 42 when the temperature of the second switch module 42 is greater than the preset temperature value.

In this way, a high heat loss is prevented from damaging the first switch tube 41 and the second switch tube 42, and the first switch tube 41 and the second switch tube 42 are protected.

In summary, for a scenario in which a power adapter charges a plurality of mobile phones 200 through one charging port 10, the charging current and the charging voltage transmitted on each channel can be regulated just by controlling the first switch tube 41 to operate in the saturation region or the linear region and controlling the second switch tube 42 to operate in the saturation region or the linear region. Compared with a step-down converter (buck circuit), the power adapter 100 according to this application is simple in structure, and the power adapter 100 is cost-efficient and downsized, and is improved in the charging energy efficiency. The charging voltage and charging current on each power channel can be controlled flexibly, thereby improving user experience in charging a plurality of mobile phones.

### Scenario III

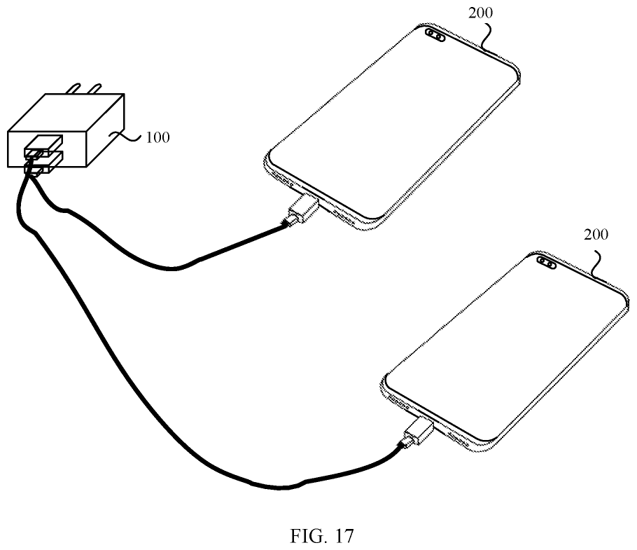

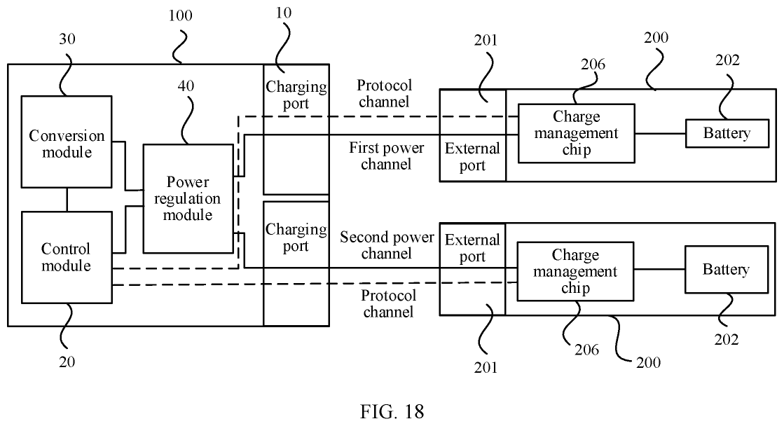

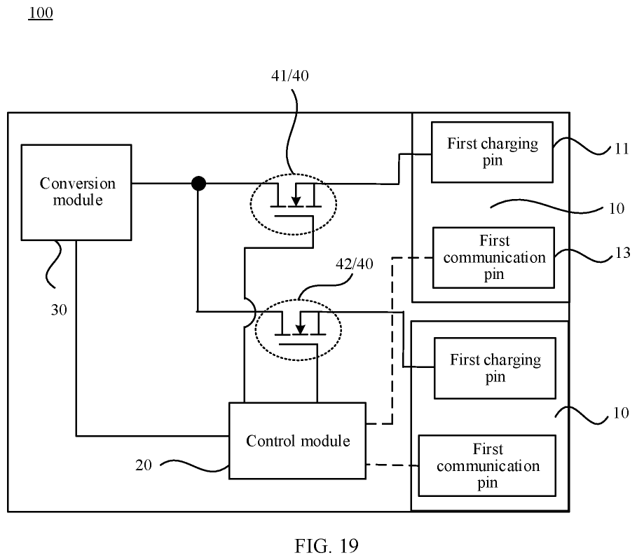

Referring to FIG. 17 and FIG. 18, FIG. 17 and FIG. 18 are schematic diagrams of another application scenario of a power adapter according to an embodiment of this application. The difference from the preceding example is that the power adapter 100 charges batteries 203 in at least two mobile phones 200 through at least two charging ports 10. The number of batteries 203 in each mobile phone 200 is one. FIG. 17 and FIG. 18 illustrate an example in which the power adapter 100 charges the batteries 203 in two mobile phones 200 through two charging ports 10. The two mobile phones 200 are a first mobile phone 208 and a second mobile phone 209 respectively. The power adapter 100 is electrically connected to the first mobile phone 208 by one of the charging ports 10, and is electrically connected to the second mobile phone 209 by the other charging port 10. To be specific, in this application scenario, a plurality of charging ports 10 of the power adapter 100 are electrically connected to a plurality of mobile phones 200 in one-to-one correspondence, so as to charge the batteries 203 in different mobile phones 200 through different charging ports 10.

It is to be noted that explanations of the terms identical or equivalent to the terms in the above embodiments are omitted here.

The following describes various structures of the power adapter 100 in the above scenario in detail.

Referring to FIG. 19, the power regulation module 40 includes two switch tubes and two charging ports 10. The two switch tubes are a first switch tube 41 and a second switch tube 42 respectively. Each charging port 10 includes a first charging pin 11 and a first communication pin 13. Both the first switch tube 41 and the second switch tube 42 include a first end, a second end, and a control end. The conversion module 30 includes an input end, an output end, and a control end. When the input end of the conversion module 30 is electrically connected to a power supply 300, the input end of the conversion module 30 is configured to receive an alternating-current voltage output by the power supply 300. The output end of the conversion module 30 is electrically connected to the first end of the first switch tube 41 and the first end of the second switch tube 42 separately. The second end of the first switch tube 41 is electrically connected to the first charging pin 11 in one of the charging ports 10. The second end of the second switch tube 42 is electrically connected to the first charging pin 11 in another charging port 10. The control end of the conversion module 30, the control end of the first switch tube 41, and the control end of the second switch tube 42 are electrically connected to the control module 20 separately. The first communication pins 13 in the two charging ports 10 are both electrically connected to the control module 20.

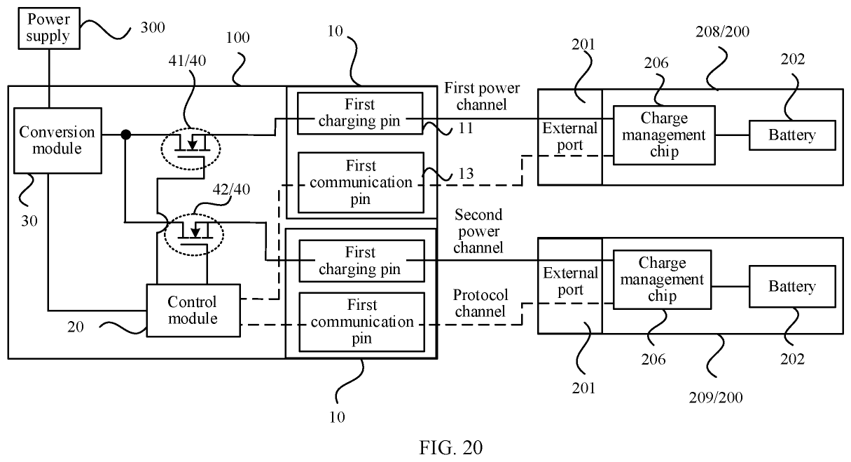

Referring to FIG. 20, when the power adapter 100 needs to charge the first mobile phone 208 and the second mobile phone 209, one end of the power adapter 100 is electrically connected to the power supply 300, and the other end of the power adapter is electrically connected to the mobile phone 200. That is, the input end of the conversion module 30 of the power adapter 100 is electrically connected to the power supply 300, and the power adapter 100 is electrically connected to the first mobile phone 208 and the second mobile phone 209 separately by the charging port 10. The external port 201 of the first mobile phone 208 is electrically connected to the first charging pin 11 in one of the charging ports 10 and the first communication pin 13 to implement electrical connection between the power adapter 100 and the first mobile phone 208. The external port 201 of the second mobile phone 209 is electrically connected to the first charging pin 11 in the other charging port 10 and the first communication pin 13 to implement electrical connection between the power adapter 100 and the second mobile phone 209. A path formed by the output end of the first switch tube 41, the first charging pin 11 in one of the charging ports 10, the external port 201 of the first mobile phone 208, and a charge management chip 206 is a first power channel. A path formed by the output end of the second switch tube 42, the first charging pin 11 in the other charging port 10, the external port 201 of the second mobile phone 209, and the charge management chip 206 is a second power channel. A path formed by the first communication pin 13 in one of the charging ports 10 and the external port 201 of the first mobile phone 208 is a protocol channel of the first mobile phone 208. A path formed by the first communication pin 13 in the other charging port 10 and the external port 201 of the second mobile phone 209 is a protocol channel of the second mobile phone 209.

The charging principles in this scenario are the same as those in the above example. Reference may be made to the above embodiment (Scenario II), and details are omitted here.

It is to be noted that, in a case that the power adapter 100 can charge two mobile phones 200 separately, the specific structure and batteries of the mobile phone 200 are not particularly limited herein. In other words, regardless of the specific structure inside the mobile phone 200, the power adapter 100 can charge a plurality of mobile phones 200. The mobile phones are not limited to the mobile phone 200 shown in FIG. 20.

In addition, in this embodiment, the heat loss of the first switch tube 41 and the second switch tube 42 also needs to be monitored in real time. The specific monitoring steps are the same as those in the above embodiment. Reference may be made to the above embodiment, and details are omitted here.

In addition, when the charging power of the first mobile phone 208 is different from the charging power of the second mobile phone 209, that is, when the voltage and current transmitted on the first power channel are different from those transmitted on the second power channel, in order to alleviate the severe heating of the switch tube operating in the linear region and enhance the energy efficiency, the operating mode of the switch tube corresponding to one of the mobile phones 200 may be set to an on-off mode, that is, intermittently on and off. In a case of turning on the switch tube, the switch tube may be turned on in a saturation manner or a linear manner. The operating mode of the switch tube corresponding to the other mobile phone 200 is a normally-on mode, and this switch tube may operate in the saturation region or linear region. In this way, the switch tube turned on intermittently can alleviate self-heating by operating intermittently. When the switch tube turned on intermittently is turned off, if the switch tube working in a normally open mode operates in the linear region at this time, the output voltage of the conversion module 30 can be changed by the control module 20 to cause the switch tube to operate in the saturation region, thereby alleviating the heating of the switch tube and improving energy efficiency.

In addition, the first mobile phone 208 monitors the status of the internal battery 203 in real time. When determining that the battery 203 is damaged, the first mobile phone sends a turn-off message to the control module 20 through the protocol channel, where the turn-off message is an instruction to turn off the switch tube corresponding to the damaged battery. Based on the turn-off message, the control module 20 turns off the switch tube. The second mobile phone 209 monitors the status of the internal battery 203 in real time. When determining that the battery 203 is damaged, the second mobile phone sends a turn-off message to the control module 20 through the protocol channel, where the turn-off message is an instruction to turn off the switch tube corresponding to the damaged battery. Based on the turn-off message, the control module 20 turns off the switch tube. In this way, the faulty battery can be automatically isolated by controlling the on and off states of the switch tube, and the method is simple.

In addition, in order to ensure accuracy of the current and voltage transmitted on the first power channel and the second power channel, where the accuracy means that the voltage and current on the first power channel are the charging current and charging voltage required by the first mobile phone 208 and that the voltage and current on the second power channel are the charging current and charging voltage required by the second mobile phone 209, the second end of the first switch tube 41 and the second end of the second switch tube 42 are electrically connected to the control module 20 separately. The specific connection manner and principles are the same as those in the above example. Reference may be made to the above embodiment, and details are omitted here.

In addition, a voltage filtering and regulation module 50 is also disposed in this embodiment. The location, purposes, and type of the voltage filtering and regulation module 50 are the same as those in the above example. Reference may be made to the above embodiment, and details are omitted here.

The specific structures and functions of the control module 20 and the conversion module 30 are the same as those in the above example. Reference may be made to the above embodiment, and details are omitted here.

The type of the charging ports 10, the pinout of the internal pins of the charging ports, and the like are the same as those in existing technologies. For specific structures of the charging ports, reference may be made to the technical solutions in existing technologies, and details are omitted herein.

An embodiment of this application further provides a charging method. The charging method and effects thereof are the same as those in the above example (Scenario II). Reference may be made to the above embodiment, and details are omitted here.

In summary, for a scenario in which a power adapter 100 charges a plurality of mobile phones 200 through a plurality of charging ports 10, the charging current and the charging voltage transmitted on each channel can be regulated just by controlling the first switch tube 41 to operate in the saturation region or the linear region and controlling the second switch tube 42 to operate in the saturation region or the linear region. Compared with a step-down converter (buck circuit), the power adapter 100 according to this application is simple in structure, and the power adapter 100 is cost-efficient and downsized, and is improved in the charging energy efficiency. The charging voltage and charging current on each power channel can be controlled flexibly, thereby improving user experience in charging a plurality of mobile phones.

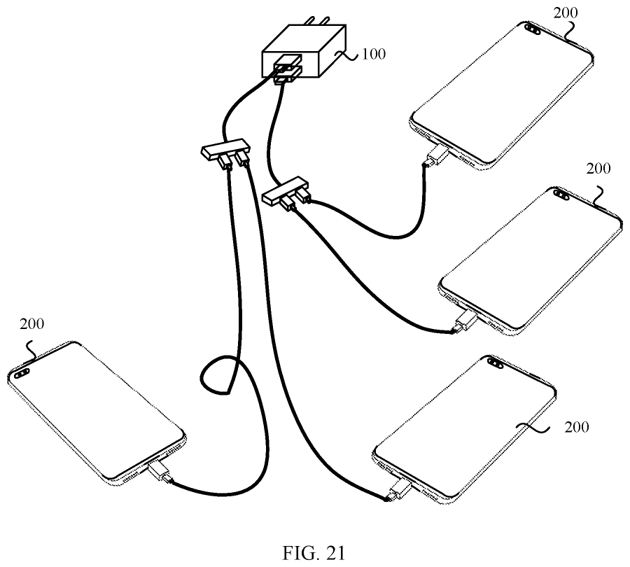

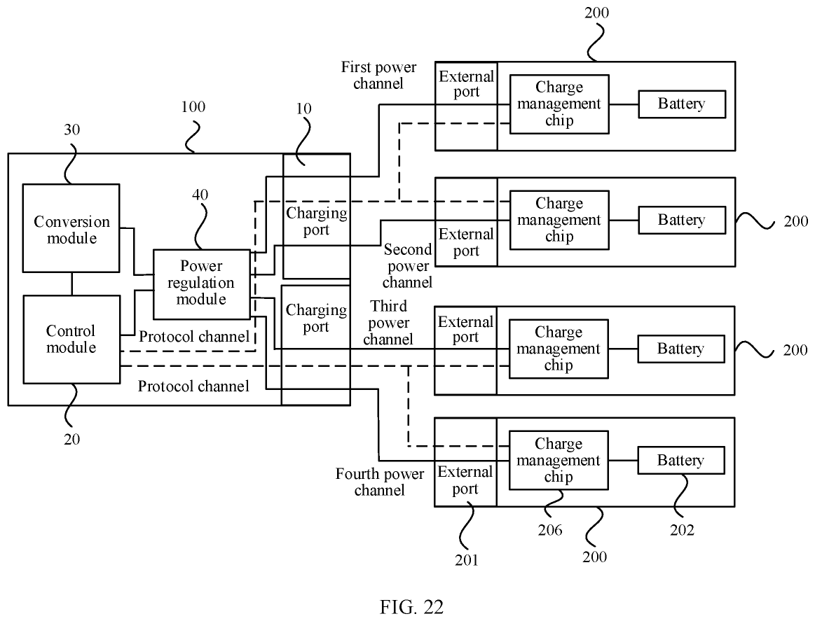

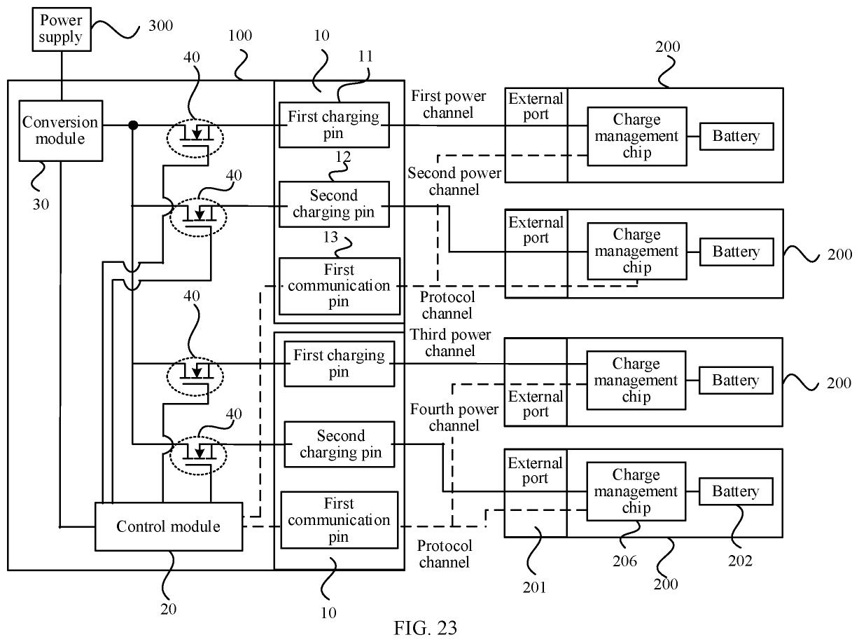

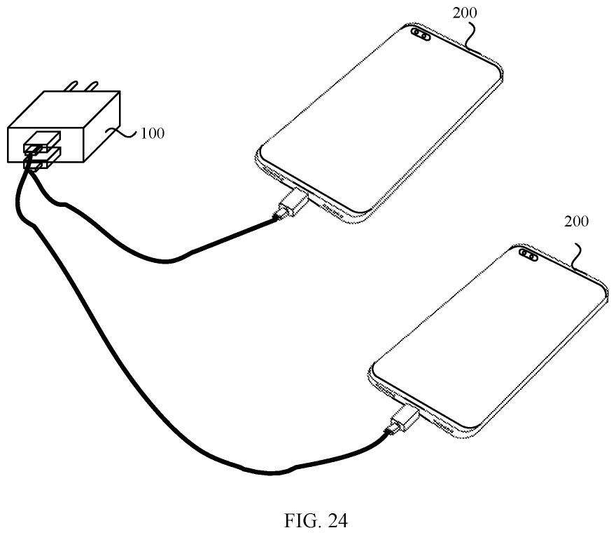

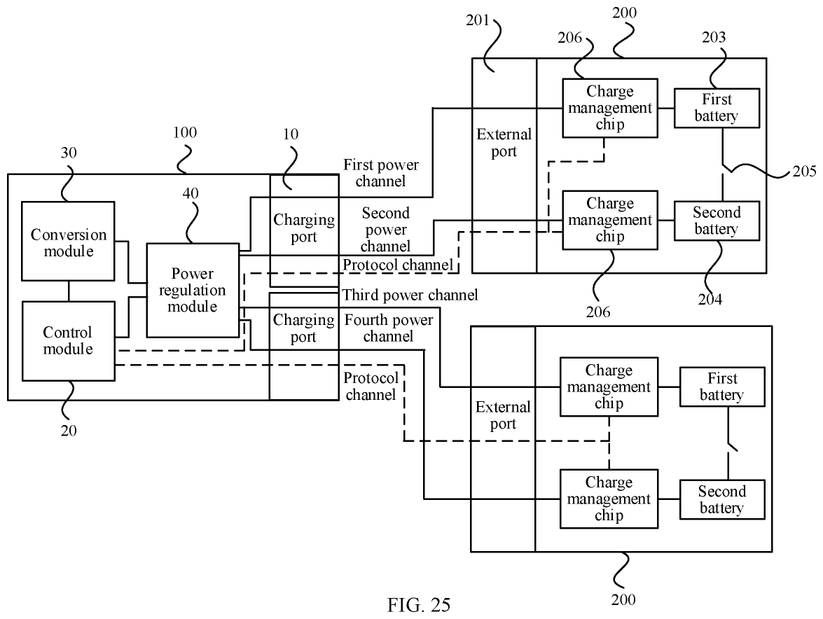

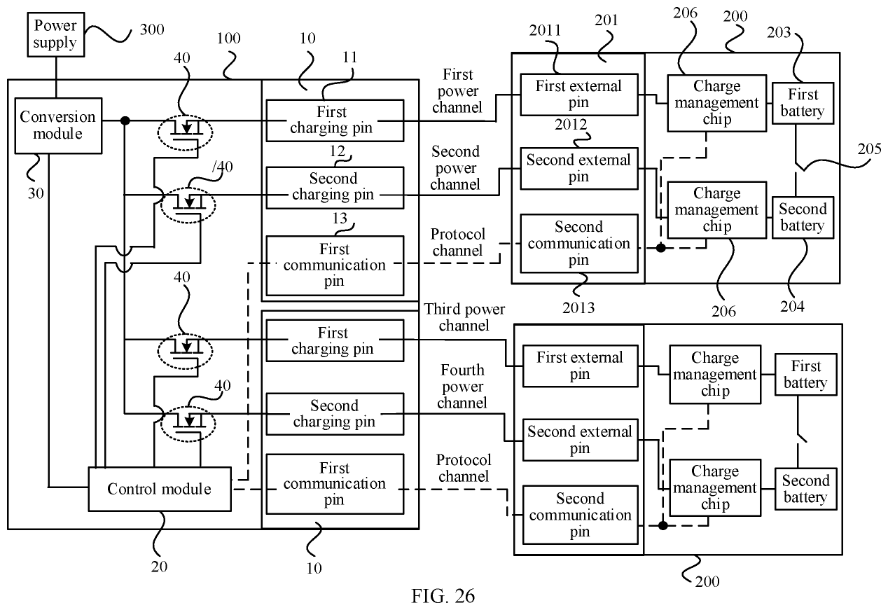

It is to be noted that the power adapter 100 according to this embodiment of this application can not only charge a plurality of batteries 202 in one mobile phone 200, but also charge the batteries 202 in a plurality of mobile phones 200 through one charging port 10, and charge the batteries 202 in different mobile phones 200 through different charging ports 10. Definitely, the power adapter 100 is not limited to the above scenarios. For example, referring to FIG. 21 to FIG. 23, the power adapter 100 includes a plurality of charging ports 10. Each charging port 10 corresponds to a plurality of mobile phones 200. Each charging port 10 may correspond to the same number or a different number of mobile phones 200. Referring to FIG. 24 to FIG. 26, the power adapter 100 includes a plurality of charging ports 10. Each charging port 10 corresponds to one mobile phone 200. Each mobile phone 200 contains a plurality of batteries 202. Each mobile phone 200 may contain the same number or a different number of batteries 202. For the specific charging principles in the two examples above, reference may be made to the above embodiments, and details are omitted here.

In the power adapter 100 according to this embodiment of this application, the charging current and the charging voltage transmitted on each channel can be regulated just by controlling each switch tube 41 to operate in the saturation region or the linear region, thereby simplifying the structure, reducing the cost of the power adapter 100, reducing the size of the power adapter 100, and improving charging energy efficiency. The charging voltage and charging current on each power channel can be controlled flexibly, thereby improving user experience in charging.

The foregoing embodiments are merely intended for describing the technical solutions of this application, but not for limiting this application. Although this application is described in detail with reference to the foregoing embodiments, a person of ordinary skill in the art understands that modifications may still be made to the technical solutions described in the foregoing embodiments, or equivalent replacements may still be made to some technical features thereof, without departing from the scope of the technical solutions of the embodiments of this application.

1. A power adapter, comprising: a control module, a conversion module, a power regulation module, and at least one charging port, wherein
the conversion module comprises an input end, an output end, and a control end;
the power regulation module comprises N switch tubes; each switch tube comprises a first end, a second end, and a control end; and N is a positive integer greater than or equal to 1;
the control end of the conversion module and the control ends of the N switch tubes are all electrically connected to the control module; the output end of the conversion module is electrically connected to the first ends of the N switch tubes separately; and the second ends of the N switch tubes are electrically connected to the charging port separately;
the control module is configured to: receive at least one charging power sent by at least one terminal, wherein each charging power comprises a charging voltage and a charging current; and determine an output voltage of the conversion module based on the charging power;
the conversion module is configured to receive a first control signal sent by the control module, converts an alternating-current voltage received by the input end into the output voltage, and transmits the output voltage to the first end of each of the switch tubes;
the control module is configured to send a second control signal to the switch tube; the switch tube operates in a linear region or a saturation region based on the second control signal, regulates voltage and current of the second end to be the charging voltage and the charging current respectively, and outputs the voltage and current through the charging port; and
the voltage and current at the second end of one of the switch tubes correspond to one charging power.

2. The power adapter according to claim 1, wherein the control module is further configured to send a second control signal to the switch tube based on the output voltage.

3. The power adapter according to claim 1, wherein a number of the charging ports is M, and the M charging ports comprise L₁ charging pins, L₂ charging pins, . . . , and Lₙ charging pin, respectively, and n, M, L₁, L₂, . . . , and Lₙ are all positive integers greater than or equal to 1; and
the second ends of the N switch tubes are electrically connected to (L₁+L₂+ . . . +Lₙ) charging pins in one-to-one correspondence.

4. The power adapter according to claim 3, wherein the number of the charging ports is N, and each of the charging ports comprises one charging pin; and
the second ends of the N switch tubes are electrically connected to the N charging pins in one-to-one correspondence.

5. The power adapter according to claim 3, wherein the number of the charging ports is one, and the charging port comprises N charging pins; and
the second ends of the N switch tubes are electrically connected to the N charging pins in one-to-one correspondence.

6. The power adapter according to claim 1, wherein the second ends of the N switch tubes are electrically connected to the control module; and
the control module is configured to collect a voltage value and a current value of the second end of each switch tube, determine whether the voltage value at the second end of the switch tube is identical to the charging voltage, and determine whether the current value at the second end of the switch tube is identical to the charging current; and, change, when the voltage value at the second end of the switch tube is different from the charging voltage and/or the current value at the second end of the switch tube is different from the charging current, the second control signal output to the switch tube, so as to change an operating point of the switch tube in the linear region.

7. The power adapter according to claim 1, wherein the power adapter further comprises N voltage filtering and regulation modules, and the N voltage filtering and regulation modules are electrically connected to the second ends of the N switch tubes in one-to-one correspondence; and
each of the voltage filtering and regulation modules is configured to filter the voltage and current at the second end of the switch tube.

8. The power adapter according to claim 1, wherein the control module is further configured to determine a power loss of the switch tube based on an operating point of the switch tube in the linear region, determine whether the power loss is greater than a preset power loss value, and turn off the switch tube when the power loss is greater than the preset power loss value.

9. The power adapter according to claim 1, wherein the power adapter further comprises a temperature sensor; and
the temperature sensor is configured to collect a temperature value of the switch tube, and send the temperature value of the switch tube to the control module;
the control module is configured to determine whether the temperature value of the switch tube is higher than a preset temperature value, and turn off the switch tube when the temperature value of the switch tube is higher than the preset temperature value.

10. The power adapter according to claim 1, wherein the control module is configured to determine a maximum voltage based on the charging voltage in the charging power, and adjust, based on the maximum voltage, the first control signal sent to the conversion module, so that the conversion module converts the alternating-current voltage received by the input end into the maximum voltage.

11. The power adapter according to claim 1, wherein, when at least one of the switch tubes operates in the linear region, the control module is configured to adjust the second control signal output to at least one switch tube so that the at least one switch tube is turned on intermittently.

12. The power adapter according to claim 1, wherein the switch tube comprises a metal oxide semiconductor or a triode.

13. The power adapter according to claim 7, wherein the voltage filtering and regulation module comprises a capacitor.

14. A charging method, applied to a power adapter, wherein the power adapter comprising: a control module, a conversion module, a power regulation module, and at least one charging port, wherein
the conversion module comprises an input end, an output end, and a control end;
the power regulation module comprises N switch tubes; each switch tube comprises a first end, a second end, and a control end; and N is a positive integer greater than or equal to 1;
the control end of the conversion module and the control ends of the N switch tubes are all electrically connected to the control module; the output end of the conversion module is electrically connected to the first ends of the N switch tubes separately; and the second ends of the N switch tubes are electrically connected to the charging port separately;
the control module is configured to receive at least one charging power sent by at least one terminal, wherein each charging power comprises a charging voltage and a charging current; and determine an output voltage of the conversion module based on the charging power;
the conversion module is configured to receive a first control signal sent by the control module, converts an alternating-current voltage received by the input end into the output voltage, and transmits the output voltage to the first end of each of the switch tubes;
the control module is configured to send a second control signal to the switch tube; the switch tube operates in a linear region or a saturation region based on the second control signal, regulates voltage and current of the second end to be the charging voltage and the charging current respectively, and outputs the voltage and current through the charging port; and
the voltage and current at the second end of one of the switch tubes correspond to one charging power, wherein
the charging method comprises:
receiving at least one charging power sent by at least one terminal, wherein each charging power comprises a charging voltage and a charging current;
determining an output voltage of the conversion module based on the charging power;
sending the first control signal to the conversion module so that the conversion module converts an alternating-current voltage received by the input end into the output voltage; and
sending the second control signal to the switch tube so as to make the switch tube operate in the linear region or the saturation region.

15. The charging method according to claim 14, wherein the sending the second control signal to the switch tube comprises:
sending the second control signal to the switch tube based on the output voltage.

16. The charging method according to claim 14, wherein the second end of each of the switch tubes is electrically connected to the control module; and
the charging method further comprises:
collecting the voltage and current at the second ends of the N switch tubes;
determining whether a voltage at the second end of an i^{th} switch tube is identical to a charging voltage corresponding to the i^{th} switch tube;
adjusting, when the voltage at the second end of the i^{th} switch tube is not identical to the charging voltage corresponding to the i^{th} switch tube, the second control signal so that the voltage at the second end of the i^{th} switch tube is identical to the charging voltage corresponding to the i^{th} switch tube;
determining, when the voltage at the second end of the i^{th} switch tube is identical to the charging voltage corresponding to the i^{th} switch tube, whether a current at the second end of the i^{th} switch tube is identical to a charging current corresponding to the i^{th} switch tube;
adjusting, when the current at the second end of the i^{th} switch tube is not identical to the charging current corresponding to the i^{th} switch tube, the second control signal so that the current at the second end of the i^{th} switch tube is identical to the charging current corresponding to the i^{th} switch tube; and
returning, when the current at the second end of the i^{th} switch tube is identical to the charging current corresponding to the i^{th} switch tube, to perform the step of determining whether the voltage at the second end of the i^{th} switch tube is identical to the charging voltage corresponding to the i^{th} switch tube until completion of detecting the voltage and current at the second ends of all the N switch tubes, wherein
1≤i≤N, and i is a positive integer.

17. The charging method according to claim 14, wherein the charging method further comprises:
determining a power loss of the switch tube based on an operating point of the switch tube in the linear region;
determining whether the power loss is greater than a preset power loss value; and
turning off the switch tube when the power loss is greater than the preset power loss value.

18. The charging method according to claim 14, wherein the power adapter further comprises a temperature sensor, and the temperature sensor is configured to collect a temperature value of the switch tube, and send the temperature value of the switch tube to the control module;
the charging method further comprises:
determining whether the temperature value of the switch tube is higher than a preset temperature value; and
turning off the switch tube when the temperature value of the switch tube is higher than the preset temperature value.

19. The charging method according to claim 14, wherein the determining an output voltage of the conversion module based on at least two charging powers comprises:
determining a maximum voltage based on the charging voltage; and
adjusting, based on the maximum voltage, the first control signal sent to the conversion module, so that the conversion module converts the alternating-current voltage received by the input end into the maximum voltage.

20. A charging system, comprising a power adapter and a terminal; wherein
the power adapter comprising: a control module, a conversion module, a power regulation module, and at least one charging port, wherein
the conversion module comprises an input end, an output end, and a control end;
the power regulation module comprises N switch tubes; each switch tube comprises a first end, a second end, and a control end; and N is a positive integer greater than or equal to 1;
the control end of the conversion module and the control ends of the N switch tubes are all electrically connected to the control module; the output end of the conversion module is electrically connected to the first ends of the N switch tubes separately; and the second ends of the N switch tubes are electrically connected to the charging port separately;
the control module is configured to: receive at least one charging power sent by at least one terminal, wherein each charging power comprises a charging voltage and a charging current; and determine an output voltage of the conversion module based on the charging power;
the conversion module is configured to receive a first control signal sent by the control module, converts an alternating-current voltage received by the input end into the output voltage, and transmits the output voltage to the first end of each of the switch tubes;
the control module is configured to send a second control signal to the switch tube; the switch tube operates in a linear region or a saturation region based on the second control signal, regulates voltage and current of the second end to be the charging voltage and the charging current respectively, and outputs the voltage and current through the charging port; and
the voltage and current at the second end of one of the switch tubes correspond to one charging power; and
the terminal comprises an external port and a battery;
the external port is electrically connected to the charging port; and
the power adapter charges the battery in the terminal through the charging port and the external port.

21-24. (canceled)
